(19) United States
(12) Patent Application Publication
(10) Pub. No.: US 2012/0177262 A1
(43) Pub. Date: Jul. 12, 2012

(54) Feature Detection And Measurement In Retinal Images

(75) Inventor: Mohammed A. Bhuiyan, Pascoe Vale South (AU)

(73) Assignee: CENTRE FOR EYE RESEARCH AUSTRALIA, East Melbourne, Victoria (AU)

(21) Appl. No.: 13/392,589

(22) PCT Filed: Aug. 27, 2010
(86) PCT No.: PCT/AU2010/001110

§ 371 Date: Mar. 23, 2012

(30) Foreign Application Priority Data
Aug. 28, 2009 (AU) 2009904109

(51) Int. Cl. G06K 9/46

(52) U.S. Cl. 382/128

(57) ABSTRACT

The invention is directed to methods of detecting and/or measuring a feature in a retinal mage. The feature detected and/or measured may be one or more of the optic disc, optic disc centre, optic disc radius, vessel edge, vessel calibre/width and vessel central reflex. One method for detecting the optic disc includes analyzing an image histogram to determine intensity levels; analyzing the intensity levels to determine a threshold intensity for potential optic disc regions; determining the number of pixels for each potential optic disc region; and calculating the centre of each potential optic disc region from the number of pixels in each potential optic disc region to thereby detect the optic disc.

### FIELD OF THE INVENTION

The present invention relates to methods of detecting a feature in a retinal image. In particular, but not exclusively, the present invention relates to methods of detecting the optic disc (OD), blood vessel or vessel central reflex and/or measuring the OD centre, OD radius, vessel calibre and/or vessel central reflex.

### BACKGROUND TO THE INVENTION

Retinal vascular calibre (i.e., vessel diameter) is an important indicator in the prediction or early diagnosis of many diseases. Research shows that a change in retinal venular calibre is associated with cardiovascular disease in elderly people [1]. Retinal arteriolar narrowing is independently associated with a risk of hypertension [2] or diabetes [3]. Retinal arteriolar and venular calibre are associated with risk of stroke, heart disease, diabetes and hypertension, independent of conventional cardiovascular risk factors [20, 21, 22, 23]. Retinal vessel calibre is also independently associated with risk of 10-year incident nephropathy, lower extremity amputation, and stroke mortality in persons with type 2 diabetes [24].

The most common trends in analysis of the retinal vascular network are manual examination and semiautomatic methods, which are time consuming, costly, prone to inconsistencies and to human error. For example, the width measured manually or semi-automatically varies from one inspection to the next, even when the same grader is involved [6].

Although several research articles [6], [7], [8], [9] have appeared on retinal vascular calibre measurement, the study of vessel diameter measurement is still an open area for improvement. Most of the techniques are semi-automatic and require expert intervention. All these techniques adopt a previously defined vessel cross-sectional profile which is matched to obtain the vessel calibre or diameter. This is computationally very expensive and accuracy is compromised by the previously defined templates for determining or tracking the vascular width.

Zhou et al. [7] have applied a model-based approach for tracking and estimating widths of retinal vessels. Their model assumes that image intensity as a function of distance across the vessel displays a single Gaussian form. However, high resolution fundus photographs often display a central light reflex [10]. Intensity distribution curves are not always of single Gaussian form, such that using a single Gaussian model for simulating the intensity profile of a vessel can produce a poor fit and subsequently provide inaccurate diameter estimations [8].

Gao et al. [8] model the intensity profiles over vessel cross sections using twin Gaussian functions to acquire vessel width. This technique may produce poor results in the case of minor vessels where the contrast is less. Lowell et al. [9] have proposed an algorithm based on fitting a local 2D vessel model, which can measure vascular width to an accuracy of about one third of a pixel. However, the technique also suffers from inaccuracy in measuring the width where the contrast is much less. Huiqi et al. [6] have proposed a method for measuring the vascular width based on a matched filter, a Kalman filter and a Gaussian filter. The method considers a matched filter which is based on previously defined'templates for tracking the vessel start point. Following that Kalman filtering and Gaussian filtering are applied to trace the vessel. From the detected vessel, its cross-sectional widths are measured from the Gaussian profile which is defined initially from the observation. The implementation of this method is computationally very expensive.

Another feature in retinal images is the vessel central reflex. The central reflex is a very significant feature of the blood vessel in the retinal image which is related to hypertension [16]. A number of research articles have reported on central reflex detection. However, a significant improvement is still a necessity for accurate detection of central reflex.

Accurate OD identification can be valuable to reduce the false positive rate of algorithms designed to detect lesions which have similar color tones such as hard exudates and cotton wool spots [11], [12]. A number of research schemes [11], [13], [14], [15] have been proposed for the detection of the OD. All these techniques mainly focus on OD segmentation and need further improvement on distinguishing OD from other objects. None of the techniques is capable of accurately computing the OD centre and radius.

Any discussion of the prior art throughout the specification should in no way be considered as an admission that such prior art is widely known or forms part of the common general knowledge in the field.

In this specification, the terms “comprises”, “comprising” or similar terms are intended to mean a non-exclusive inclusion, such that a method, system or apparatus that comprises a list of elements does not include those elements solely, but may well include other elements not listed.

### SUMMARY OF THE INVENTION

The invention is broadly directed to methods of detecting and/or measuring a feature in a retinal mage. The feature detected and/or measured may be one or more of the optic disc, optic disc centre, optic disc radius, blood vessel, vessel calibre/width and vessel central reflex. The invention also provides methods of diagnosis of a vascular and/or a cardiovascular disease (CVD) and/or a predisposition thereto.

In a first aspect, although it need not be the only, or indeed the broadest aspect, the invention resides in a method for detecting an optic disc in a retinal image broadly including the steps of:

analyzing an image histogram of the retinal image to determine intensity levels;

analyzing the determined intensity levels to determine a threshold intensity for potential optic disc regions;

determining the number of pixels for each potential optic disc region; and

calculating the centre of each potential optic disc region from the number of pixels in each potential optic disc region to thereby detect the optic disc.

The determination of the number of pixels for each potential optic disc region may be performed using a region growing technique.

The calculation of the centre of each potential optic disc region may be performed using a Hough transformation.

In a second aspect, although again not necessarily the broadest aspect, the invention resides in a method for measuring vessel calibre in a retinal image broadly including the steps of:

determining a distribution of gradient magnitude and intensity profile in the retinal image to identify one or more boundary pixels of zone B area which can be potential vessel edge start pixel;

determining a start pixel of a vessel edge from the identified one or more boundary pixels;

mapping a vessel edge from the determined start pixel using a region growing technique; and

measuring the vessel calibre from the mapped vessel edges.

The method of the second aspect may further include the step of edge profiling for removing noise and background edges.

The method of the second aspect may further include the step of edge length thresholding for removing noise and background edges.

The method of the second aspect may further include the step of applying a rule based technique to identify and/or define individual vessels' edges.

The method of the second aspect may further include the step of calculating a vessel centreline from the mapped vessel edges wherein the calculated vessel centerline is used with the mapped vessel edge to measure the vessel calibre.

The start pixel of the vessel edge may be determined by selecting a pixel from the border of the zone B area which is part of a pattern.

The pattern may be as follows: the edge start pixel is greater than or equal to its neighboring pixels which are also greater than or equal to their other neighbors.

In one embodiment of the second aspect the mapping of a vessel edge may be performed by selecting pixels in neighboring rows and/or columns which also satisfy a criteria to generate a boundary pixel list.

In another embodiment of the second aspect the mapping of a vessel edge comprises determining an edge profile by selecting one or more pixel on both sides of the edge pixels to measure their intensity levels.

The intensity levels may be measured in a green channel image.

In one embodiment of the second aspect the start pixel of a vessel second edge may be determined from the boundary pixel list using the gradient magnitude and intensity profile.

In another embodiment of the second aspect the start pixel of a vessel second edge may be determined from the edge profile which shows opposite intensity levels than the first edge within the same direction.

The identification and/or detection of blood vessels may be performed by adopting a rule based technique which considers the first edge and second edge combination and a specific distance of the edge start points.

The calculation of the vessel centreline may be performed by grouping the edges for each vessel.

The measurement of the vessel calibre may be performed using a mask which considers a vessel centreline pixel as its centre and determines edge pixels and the mirror of each edge pixel to generate edge pixel pairs from which the width of the cross-section is calculated.

The method of the second aspect may be used to diagnose a vascular and/or a cardiovascular disease and/or a predisposition thereto.

In a third aspect, although again not necessarily the broadest aspect, the invention resides in a method for measuring a vessel central reflex broadly including the steps of:

determining a distribution of gradient magnitude and intensity profile in the retinal image to identify one or more boundary pixels;

determining a start pixel of a vessel central reflex from the identified one or more boundary pixels;

mapping a vessel central reflex edge from the determined start pixel using a region growing technique;

determining if the vessel central reflex is continuous;

calculating a vessel central reflex centreline from the mapped vessel central reflex edge; and

measuring the vessel central reflex mean width from the mapped vessel central reflex edge and calculated vessel centreline to thereby detect the vessel central reflex.

Once a central reflex boundary pixel is determined, the other edge of the central reflex may be determined.

The other edge of the central reflex may be within 15 pixels and/or 75 microns of the central reflex boundary pixel.

The region growing of the central reflex may include a stop criterion if the gradient magnitude is within the range of 60% of the start pixel if the value is lower than the current value.

The methods of the invention may also include image pre-processing such as, color channel extraction, median filtering and/or Gaussian smoothing.

The methods of the invention may also include obtaining and/or receiving a retinal image.

The methods of the invention may be computer methods.

In a fourth aspect the invention resides in a computer program product said computer program product comprising:

a computer usable medium and computer readable program code embodied on said computer usable medium for detecting an optic disc in a retinal image, the computer readable code comprising:

computer readable program code devices (i) configured to cause the computer to analyse an image histogram of the retinal image to determine intensity levels;

computer readable program code devices (ii) configured to cause the computer to analyse the determined intensity levels to determine a threshold intensity for potential optic disc regions;

computer readable program code devices (iii) configured to cause the computer to determine the number of pixels for each potential optic disc region; and

computer readable program code devices (iv) configured to cause the computer to calculate the centre of each potential optic disc region from the number of pixels in each potential optic disc region to thereby detect the optic disc.

According to the fourth aspect computer program code devices (iii) may comprise a region growing technique.

According to the fourth aspect computer program code devices (iv) may comprise a Hough transformation.

In a fifth aspect the invention resides in a computer program product said computer program product comprising:

a computer usable medium and computer readable program code embodied on said computer usable medium for measuring vessel calibre in a retinal image, the computer readable code comprising:

computer readable program code devices (i) configured to cause the computer to determine a distribution of gradient magnitude and intensity profile in the retinal image to identify one or more boundary pixels of zone B area which can be potential vessel edge start pixel;

computer readable program code devices (ii) configured to cause the computer to determine a start pixel of a vessel edge from the identified one or more boundary pixels;

computer readable program code devices (iii) configured to cause the computer to map a vessel edge from the determined start pixel using a region growing technique; and

computer readable program code devices (iv) configured to cause the computer to measure the vessel calibre from the mapped vessel edges.

According to the fifth aspect the computer readable code may further comprise computer readable program code devices (v) configured to cause the computer to perform edge profiling to remove noise and background edges.

According to the fifth aspect the computer readable code may further comprise computer readable program code devices (vi) configured to cause the computer to perform edge length thresholding for removing noise and background edges.

According to the fifth aspect the computer readable code may further comprise computer readable program code devices (vii) configured to cause the computer to apply a rule based technique to identify and/or define individual vessels' edges.

According to the fifth aspect the computer readable code may further comprise computer readable program code devices (viii) configured to cause the computer to calculate a vessel centreline from the mapped vessel edges wherein the calculated vessel centerline is used with the mapped vessel edge to measure the vessel calibre.

According to the fifth aspect, the start pixel of the vessel edge may be determined by selecting a pixel from the zone B area which has a pattern.

The pattern may be two neighbouring pixels with non-zero value and two with zero values.

In one embodiment of the fifth aspect the mapping of a vessel first edge may be performed by selecting pixels in neighboring rows and/or columns which also satisfy the criteria to generate a boundary pixel list.

In another embodiment of the fifth aspect the mapping of a vessel edge comprises determining an edge profile by selecting one or more pixel on both sides of the start pixels to measure their intensity levels.

The intensity levels may be measured in a green channel image.

In one embodiment of the fifth aspect the start pixel of a vessel second edge may be determined from the boundary pixel list using the gradient magnitude and intensity profile.

In another embodiment of the fifth aspect the start pixel of a vessel second edge may be determined from the edge profile which shows opposite intensity levels than the first edge within the same direction.

In yet another embodiment of the fifth aspect the detection of blood vessels may be performed by adopting a rule based technique which considers the first edge and second edge combination and a specific distance of the edge start points.

In still another embodiment of the fifth aspect the calculation of the vessel centreline may be performed by grouping the edges for each vessel by listing the pixels in each edge.

In another embodiment of the fifth aspect the measurement of the vessel calibre may be performed using a mask which considers a vessel centreline pixel as the centre and determines edge pixels and the mirror of each edge pixel to generate edge pixel pairs from which the width of the cross-section is calculated.

In yet another embodiment of the fifth aspect the computer readable code may further comprise computer readable program code devices (ix) configured to cause the computer to provide a diagnosis or indication of a vascular and/or a cardiovascular disease or a predisposition thereto.

In a sixth aspect the invention resides in a computer program product said computer program product comprising:

a computer usable medium and computer readable program code embodied on said computer usable medium for measuring a vessel central reflex in a retinal image, the computer readable code comprising:

computer readable program code devices (i) configured to cause the computer to determine a distribution of gradient magnitude and intensity profile in the retinal image to identify one or more boundary pixels;

computer readable program code devices (ii) configured to cause the computer to determine a start pixel of a vessel central reflex from the identified one or more boundary pixels;

computer readable program code devices (iii) configured to cause the computer to map a vessel central reflex edge from the determined start pixel using a region growing technique;

computer readable program code devices (iv) configured to cause the computer to determine if the vessel central reflex is continuous;

computer readable program code devices (v) configured to cause the computer to calculate a vessel central reflex centreline from the mapped vessel central reflex edge; and

computer readable program code devices (vi) configured to cause the computer to measure the vessel central reflex mean width from the mapped vessel central reflex edge and calculated vessel centreline to thereby detect the vessel central reflex.

In one embodiment of the sixth aspect the computer readable code may further comprise computer readable program code devices (viii) configured to cause the computer to determine the other edge of the central reflex.

According to the sixth aspect the other edge of the central reflex may be within 15 pixels and/or 75 microns of the central reflex boundary pixel.

According to the sixth aspect the region growing of the central reflex may include a stop criterion if the gradient magnitude is within the range of 60% of the start pixel if the value is lower than the current value.

In a seventh aspect the invention resides in an apparatus or machine for performing the methods according to the first, second and/or third aspects.

Further features of the present invention will become apparent from the following detailed description.

### BRIEF DESCRIPTION OF THE DRAWINGS

In order that the present invention may be readily understood and put into practical effect, reference will now be made to the accompanying illustrations, wherein like reference numerals refer to like features and wherein:

FIG. 1A is a general flow diagram showing a method of detecting an optic disc (OD) in a retinal image according to one embodiment of the invention;

FIG. 1B is a general flow diagram showing a method for measuring vessel calibre in a retinal image according to another embodiment of the invention;

FIG. 1C is a general flow diagram showing a method for detecting vessel central reflex according to another embodiment of the invention;

FIG. 1D is a schematic diagram illustrating an apparatus according to another embodiment of the invention for performing the methods described herein;

FIG. 2 is a general flow diagram illustrating a method for measuring vessel calibre according to another embodiment of the invention;

FIG. 3 is a general flow diagram showing one embodiment of the OD detection method of the invention;

FIGS. 4(a) and 4(c) show red charinel retinal images;

FIGS. 4(b) and 4(d) show respective histograms for the retinal images in FIGS. 4(a) and 4(c);

FIGS. 5 (a) and (c) show retinal images taken from the DRIVE database and the STARE database respectively;

FIGS. 5(b) and (d) show thresholded output images created respectively from the retinal images shown in FIGS. 5 (a) and (c);

FIG. 6 shows the thresholded image (left) and potential OD regions (right) for the two images shown in FIG. 5;

FIG. 7(a) shows a retinal gray scale image;

FIG. 7(b) shows a thresholded image comprising optic disc pixels obtained from the retinal image of FIG. 7(a);

FIG. 7(c) shows a square shaped region selected in an edge image;

FIG. 7(d) shows a detected centre of the optic disc indicated by an arrow;

FIG. 7(d) shows a larger size version of FIG. 7c);

FIG. 8 is a retinal image showing the region selected for pre-processing and gradient operation;

FIG. 9 is a median filtered green channel image;

FIG. 10 is an image obtained after applying Gaussian smoothing;

FIG. 11(a) is a retinal gray scale image;

FIG. 11(b) shows the Zone B area of the image in FIG. 11(a);

FIG. 11(c) shows a gradient magnitude image of the Zone B area in FIG. 11(b);

FIG. 11(d) shows a larger and clearer version of FIG. 11(b);

FIG. 11(e) shows a larger and clearer version of FIG. 11(c);

FIG. 12(a) shows an edge image produced by the known Sobel operator;

FIG. 12(b) shows an edge image produced by the known Canny operator;

FIG. 12(c) shows an edge image produced by the known zero crossing operator;

FIG. 13 is a threshold image showing thick vessel edges and central reflex;

FIG. 14 shows criteria to consider a border pixel;

FIG. 15 is an image showing the pixels traversed (bold and black colour) and pixels not considered for traversal (underlined);

FIG. 16 is a chart showing the distribution of gradient magnitude to consider the pixel as a start pixel of a vessel edge;

FIG. 17(a) is a graph showing an intensity profile for a vessel first edge or a central reflex second edge;

FIG. 17(b) is a graph showing an intensity profile of a vessel second edge or a central reflex first edge;

FIG. 18 is a general flow diagram showing one embodiment of a method of selecting the start pixel of the vessel edge;

FIGS. 19(a)-(c) show different pixel grouping conditions;

FIG. 20 is a grid showing centreline pixels and edge pixels used in the vessel centreline detection method;

FIG. 21 illustrates finding the mirror of an edge pixel for a vessel;

FIG. 22 shows the determination of vessel width or minimum distance from potential pairs of edge pixels;

FIG. 23 is a grid showing the potential width edge pairs for a cross-section with centreline pixel C; and

FIG. 24 shows measured vessel widths indicated by white lines traversing the vessels.

Skilled addressees will appreciate that elements in at least some of the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE INVENTION

The invention relates, at least in part, to methods for detecting features in a retinal image. The present inventors have provided novel and inventive methods for detecting the optic disc or the vessel central reflex and/or measuring the optic disc centre, optic disc radius, vessel calibre and/or vessel central reflex.

As used herein “optic disc” or “OD” refers to the entrance of the vessels and optic nerve into the retina. It appears in colour fundus images as a bright yellowish or white region or disc. Its shape is more or less circular, interrupted by outgoing vessels. The OD is the origin of all retinal vessels and one of the most prominent objects in a human retina. The OD generally has a vertical oval shape, with average dimensions of 1.79±0.27 mm horizontally by 1.97±0.29 mm vertically. While these are average dimensions, the size of the OD may vary from person to person.

The OD is one of the most important features in a retinal image and can be used for many purposes. For example, the OD can be used in automatic extraction of retinal anatomical structures and lesions, such as diabetic retinopathy, retinal vascular abnormalities and cup-to-disc ratio assessment for glaucoma. In addition, it can be used as a landmark for image registration or can be used as an initial point for blood vessel detection. Based on the fixed position relationship between OD and macula center, OD position can also be used as a reference to locate macular area. The OD can be used as a marker or ruler to estimate the actual calibre of retinal vessels or image calibration.

“Zone B” is the circular area starting from the distance of 2×r and ending at 3×r around the optic disc centre; where r is the radius of the optic disc.

“Vessel central reflex” in a retinal image is the light reflex through the centre of the blood vessel for which a vessel may have a hollow appearance. The central reflex should be continuous in the zone B area and its width should be approximately one third of the vessel width or more.

Herein are described new and efficient techniques which are capable of measuring vessel calibre with high accuracy. The methods are automatic and are achieved by tracing vessels around the optic disc. For this, the inventors have developed a new and efficient technique to automatically compute the OD centre and automatically compute the radius for zone B area selection.

The zone B area is considered as the most significant area in a retinal image for taking the vessel calibre into account. Hence, the vessel calibre in zone B only may be computed to give improved efficiency. Once the zone B area has been computed, the vessel edge start point is traced from the border of the zone B area. Based on this start point the edge may be detected. Following this, the retinal vessel centreline may be obtained and the vessel cross-sectional width may be computed. The vessel calibre can be used to measure Central Retinal Artery Equivalent (CRAE) and Central Retinal Vein Equivalent (CRVE) to diagnose vascular and/or cardiovascular Diseases (CVDs).

Retinal images may be obtained from any suitable source such as a fundus retinal camera, a database of retinal images or the like. One example of a suitable fundus retinal camera is a Canon D-60 digital fundus camera.

In some embodiments the retinal image is received by the methods of the invention. In other embodiments the retinal image is obtained as part of the methods of the invention.

The present invention uses vessel centreline and edge information, from which the vessel cross-sectional width or calibre is measured with high accuracy and efficiency. The invention detects the OD and computes the Zone B area automatically using the OD centre and radius information. The vessel calibre may be measured from the zone B area only, from which the CRAE and CRVE may be computed. Therefore, the invention achieves very high efficiency by applying the method in zone B area for edge detection, centreline computation and vessel width measurement.

In this specification distances may be measured in pixels. Any distance may also be measured in microns using microns per pixel information.

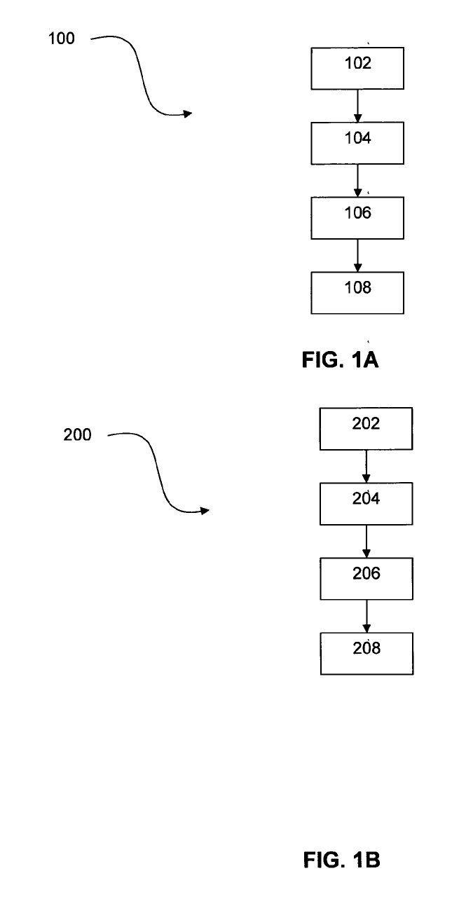

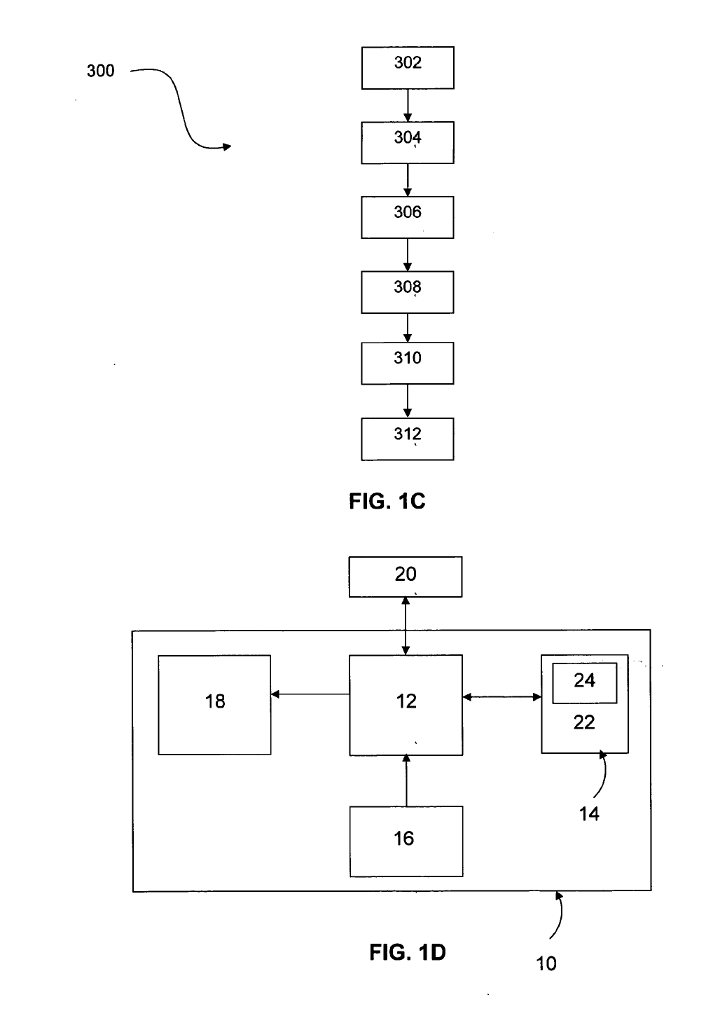

FIG. 1A shows one embodiment of a method 100 of the invention in which an optic disc is detected in a retinal image. According to method 100 in step 102 an image histogram of the retinal image is analyzed to determine intensity levels.

In step 104 the determined intensity levels are analyzed to determine a threshold intensity for potential optic disc regions.

In step 106 the number of pixels for each potential optic disc region is determined.

Then in step 108 the center of each potential optic disc region is calculated from the number of pixels in each potential optic disc region.

FIG. 1B shows a method 200 for measuring vessel calibre in a retinal image in accordance with another embodiment of the invention.

In step 202 a distribution of gradient magnitude and intensity profile in the retinal image is determined to identify one or more boundary pixels.

In step 204 a start pixel of a vessel edge is determined from the identified one or more boundary pixels.

In step 206 a vessel edge is mapped from the determined start pixel using a region growing technique.

In step 208 the vessel calibre is measured from the mapped vessel edge.

Method 200 may also include the optional steps of edge profiling 210 (not shown) and edge length thresholding 212 (not shown) which are performed to remove noise and background edges.

Another optional step that may be included in method 200 is step 214 (not shown) of applying a rule based technique to identify and/or define individual vessel edges (i.e., vessel boundary).

Yet another optional step that may be included in method 200 is step 216 (not shown) of calculating a vessel centreline from the mapped vessel edges. When step 216 is included in method 200, step 208 the calculated centerline is used along with the mapped vessel edge to measure the vessel calibre.

FIG. 1C shows another method 300 for detecting vessel central reflex.

In step 302 a distribution of gradient magnitude and intensity profile in the retinal image is determined to identify one or more boundary pixels.

In step 304 a start pixel of a vessel central reflex is determined from the identified one or more boundary pixels.

In step 306 a vessel central reflex edge is mapped from the determined start pixel using a region growing technique.

In step 308 whether the vessel central reflex is continuous is determined.

In step 310 a vessel central reflex centreline is calculated from the mapped vessel central reflex edge.

In step 312 the vessel central reflex mean width is calculated from the mapped vessel central reflex edge and calculated vessel centreline.

With reference to FIG. 1D, an apparatus or machine 10 for performing methods 100, 200, 300 in accordance with embodiments of the present invention comprises a processor 12 operatively coupled to a storage medium in the form of a memory 14. One or more input device 16, such as a keyboard, mouse and/or pointer, is operatively coupled to the processor 12 and one or more output device 18, such as a computer screen, is operatively coupled to the processor 12.

Memory 14 comprises a computer or machine readable medium 22, such as a read only memory (e.g., programmable read only memory (PROM), or electrically erasable programmable read only memory (EEPROM)), a random access memory (e.g. static random access memory (SRAM), or synchronous dynamic random access memory (SDRAM)), or hybrid memory (e.g., FLASH), or other types of memory as is well known in the art. The computer readable medium 22 comprises computer readable program code components 24 for performing the methods 100, 200, 300 in accordance with the teachings of the present invention, at least some of which are selectively executed by the processor 12 and are configured to cause the execution of the embodiments of the present invention described herein. Hence, the machine readable medium 22 may have recorded thereon a program of instructions for causing the machine 10 to perform methods 100, 200, 300 in accordance with embodiments of the present invention described herein.

According to the embodiment shown, a fundus retinal camera 20 for capturing the retinal images is operatively coupled to the processor 12. In other embodiments the fundus retinal camera 20 is not present and instead apparatus 10 retrieves retinal images from memory 14 or from a database 21 (not shown) external to apparatus 10, which can be accessed via a communications network such as an intranet or a global communications network.

It will be appreciated that in some embodiments the input device 16 and the output device 18 can be combined, for example, in the form of a touch screen.

The aforementioned arrangement for apparatus 10 can be a typical computing device and accompanying peripherals as will be familiar to one skilled in the art. For example, apparatus or machine 10 may be a computer such as, a computer comprising a processor 12 in the form of an Intel® Core™ 2 Duo CPU E6750 2.66 GHz and memory 14 can be in the form of 3.25 GB of RAM.

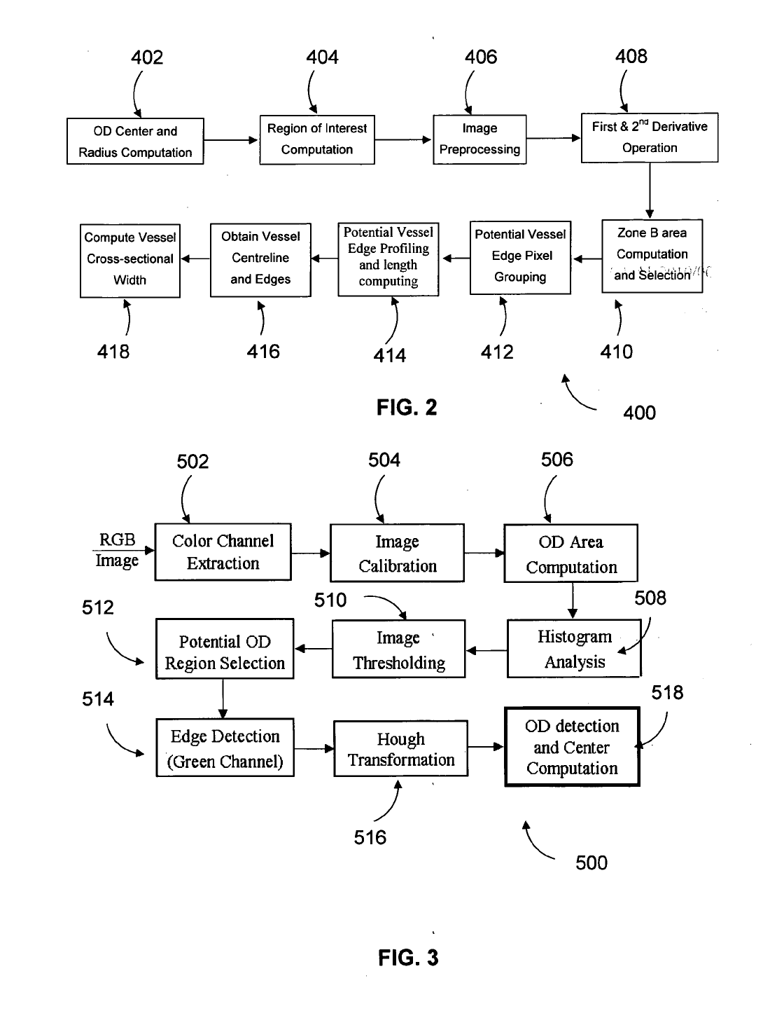

The methods 100, 200 and/or 300 can be combined and an overview of one such combination method 400 according to an embodiment of the invention is shown in the general flow diagram of FIG. 2. Each of the steps 402-418 of the overall method 400 is described generally below followed by a detailed description of each step 402-418. Based on the description herein a skilled person is readily able to select steps from the methods described herein to design other methods which achieve the effect of the invention.

According to method 400, in step 402 the OD centre and the radius of the OD are calculated. In step 404 the method 400 includes computing the region of interest within the retinal image. For example, a square shaped region with a maximum boundary of the zone B area in the image may be selected as the region of interest.

In step 406 image pre-processing techniques may be applied to remove noise from the retinal image and to smooth the image. For example, median filtering may be used to remove noise and Gaussian smoothing may be employed to smooth the image.

In step 408 method 400 includes processing the image by calculating the magnitude of the gradient of the image using a first and/or second derivative operation.

In step 410 method 400 includes calculating and selecting the Zone B area.

In step 412 method 400 includes obtaining and grouping the vessel edge pixels. As elucidated below, the magnitude of the first derivative may be considered to obtain the vessel edge pixels. For edge pixel tracking, at first, the start pixel of a vessel edge may be traced. For this the border of the zone B area may be traversed through and examined for a specific distribution of the gradient magnitude (in the gradient image) and intensity profile (in the original smoothed image). Based on this start pixel, the region growing procedure may be applied to trace the vessel edge pixels which satisfy the required criteria described below.

The central reflex may also be considered because it also has edge properties. To skip the central reflex and to detect the edges of the vessel, the distance (edge position) of central reflex edge start point and the information of parallel edge of vessel and the central reflex are considered.

In step 414 method 400 includes determining the potential vessel edges by removing the noise and background edges through edge profiling and length computation.

In step 416 method 400 includes determining the vessel centreline and the vessel edges. The vessel centrelihe may be determined after both edges of a vessel are obtained, for example, by passing a mask through the edges.

In step 418 the vessel cross-sectional width is measured, for example, by mapping the edge pixels based on the centreline pixels.

Step 402—OD Centre and Radius'Computation

The method 100 of the invention accurately and efficiently detects the OD and computes the OD radius and center. Embodiments of the method use geometrical features of the OD such as, size and/or shape and are based on image global intensity levels, OD size and/or shape analysis. The reasons for considering these features are as follows. Firstly, the OD is the brightest part on the image and its pixel intensity values may be approximated by analysing the image histogram. Secondly, the OD is more or less circular in shape and the size of the OD can be specified within a particular range for any person. Therefore, incorporating size and shape information along with the pixel intensity provides the highest accuracy in OD detection.

FIG. 3 shows a general flow diagram of an embodiment of the overall method 500 for detecting the OD and in particular for computing the OD center and radius. It is to be understood that the steps of method 500 may also be used in method 100.

In step 502 a received colour RGB (red green blue) retinal image is processed by colour channel extraction. In this pre-processing step one or more potential OD regions are identified from which the OD will be detected. In one embodiment, the red colour channel is extracted which provides the highest contrast between the OD and the background. Moreover, in this colour channel, the OD has a better texture and the vessels are not obvious in its centre. Therefore, for potential OD region selection the red channel is preferred because it provides the best intensity profile for the OD among all the colour channels. However, it will be appreciated that in other embodiments, the green or blue colour channels may be used.

In step 504, method 500 includes the pre-processing step of calibrating the retinal image to obtain a microns-per-pixel value. The reasons for performing image calibration are as follows. Firstly, the actual radius of the OD is used and the number of microns-per-pixel is usually unknown in the image, for example when image data sets are used. Secondly, a confirmation of the number of microns-per-pixel is required because a different camera may be used to capture the retinal images (as a standard procedure).

In one embodiment the image is calibrated based on the OD diameter. The average OD diameter value used may be 1800 microns and the microns-per-pixel value may be computed for an image by drawing a circle on the OD. The ratio of 1800 microns and the circle radius is the desired microns-per-pixel value. For calibration, 10 to 15 images may be randomly selected from a particular data set and the calibrated value averaged across the images. The calibrated value may be used as a final microns-per-pixel value. This may be done automatically using software developed by the Centre for Eye Research Australia (CERA).

In step 506 in FIG. 3, the area of the OD is computed by calculating the OD diameter in pixels. As the OD is a circular shaped object the formula for circle area πr² (where r is the radius of the circle) is used to calculate the OD area. This is done to approximate the number of pixels in the OD and this number is used to find the threshold intensity value from the histogram, as described in the next step.

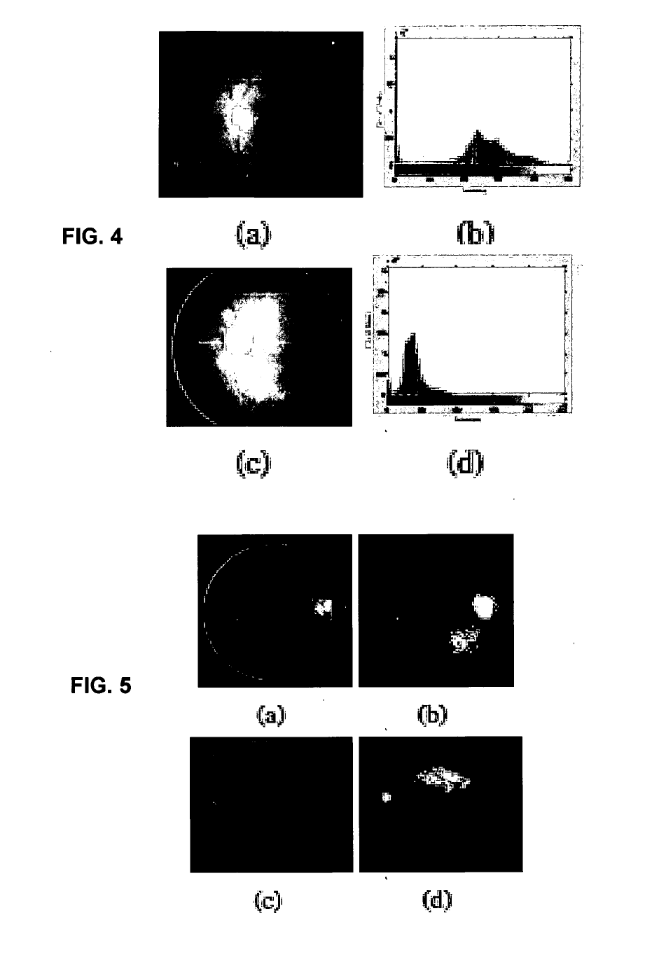

In step 508, method 500 includes analysing a histogram of the retinal image. An image histogram provides the intensity levels in the image and the number of pixels for each intensity level. The histogram of each image is analysed to find a threshold intensity for segmenting potential OD regions. After computing the histogram, the pixel number is determined for the highest intensity level and a comparison is made to determine if the number of pixels is equal to or greater than the value of 1.5×area of the OD. If not, the pixel number for highest intensity level is added to the pixel number for the next highest intensity level to provide a total value. The cumulative adding of the next highest intensity level pixel number is continued as long as the total value does not reach 1.5×area of OD or higher. Once the total value reaches 1.5×area of OD or higher, the total value may be selected as the threshold intensity value to segment the image. In this way, the threshold intensity value can be automatically calculated. FIG. 4 shows two image histograms (b) and (d) for two retinal images (a) and (c). The retinal images have varying contrasts, but the method is equally capable of determining the threshold intensity value for both retinal images. In this embodiment, the red channel images were used.

In step 510, method 500 includes thresholding the retinal image in the following way. If ƒ(x,y) is the image and T is the intensity value above or equal to which a pixel is selected as forming part of the OD, an thresholded output image g(x,y) can be created where:

$$g ( x , y ) = \{ \begin{matrix}1 & if f ( x , y ) \geq T \\ 0 & otherwise\end{matrix} \qquad ( equation 1 )$$

FIGS. 5(b) and 5(d) shows two thresholded images created from their respective retinal images FIGS. 5(a) and 5(c). The retinal images in FIGS. 5 (a) and (c) were taken from the DRIVE database and the STARE database respectively.

In step 512 of the method 500 shown in FIG. 3, the method includes selecting the potential OD regions from the thresholded image. The potential OD regions can be selected by computing the area of these regions. This is done to remove the redundant objects such as exudates, lesions, etc. The method includes determining the number of pixels for each of the potential OD regions. According to preferred embodiments, the number of pixels in each potential OD region is determined by applying a region growing technique. The potential OD region(s) which have a pixel number of approximately 50% to 150% of the OD area (pixels) can be selected.

The region growing technique categorizes pixels into regions based on a seed point or start pixel. The basic approach is to start with a pixel which is the seed point for a region to grow. In one embodiment, the start pixel or seed point is selected from scanning the thresholded image row-wise (i.e., raster scanning). From the start pixel the region grows by appending to the start pixel neighbouring pixels that have the same predefined property or properties as the seed. For example, the predefined property may be pixel intensity. In one embodiment, the predefined property is set as the gray level intensity value of 255 of the seed pixel or start pixel.

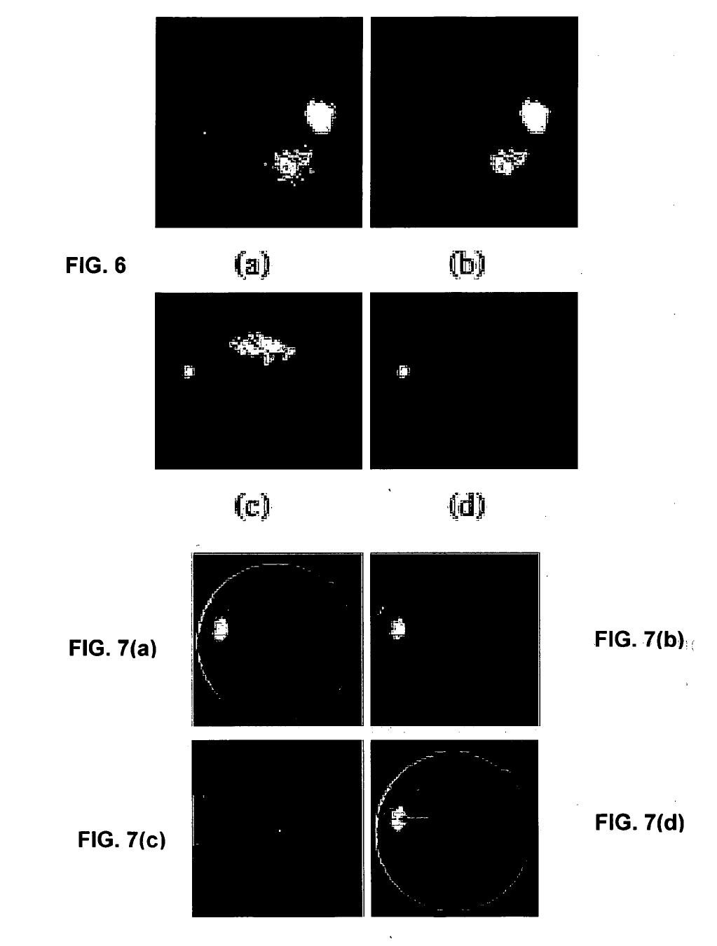

With reference to the region growing technique, a stopping rule may be applied, which is that growing of a region should stop when no more pixels satisfy the criteria for inclusion in that region. In the region growing process each region can be labelled with a unique number. The image is scanned in a row-wise manner and each pixel that satisfies the predefined property or properties is taken into account along with its 8-neighborhood connectivity. In other embodiments the image may be scanned in a column-wise manner or in both a row-wise and column-wise manner. FIGS. 6(a) and 6(c) show the same thresholded images as shown in FIGS. 5(b) and 5(d). FIGS. 6(b) and 6(d) are images of the potential OD regions determined respectively from the thresholded images in FIGS. 6(a) and 6(c). It will be noted that FIG. 6(b) comprises two potential OD regions whereas FIG. 6(d) only comprise as single potential OD region.

In step 514, method 500 shown in FIG. 3 includes detecting the edges of a square shaped region around the potential OD regions, which in some embodiments is based on the green channel of the retinal image. For each potential OD region, the centre is computed from the mean of the x-y coordinates of all the points comprising the potential OD region. The centre is used to determine the square shaped region to which a Hough transform or transformation is applied in step 516 described below. Therefore, the Hough, transformation is applied in a smaller region which provides greater efficiency in OD identification.

According to some embodiments, the square shaped region is selected from an edge image based on 1.5×diameter of the OD as its sides.

The edge image can be obtained after applying a first order partial differential operator in the retinal green channel image. The gradient of an image ƒ(x,y) at location (x,y) is defined as a two dimensional vector:

$$G [ f ( x , y ) ] = [ {G}_{x} , {G}_{y} ] = [ \frac{\partial f}{\partial x} , \frac{\partial f}{\partial y} ] \qquad ( equation 2 ]$$

It is well known from vector analysis that the vector G points in the direction of maximum rate of change of ƒ at location (x,y). For edge detection, the magnitude of G[ƒ(x,y)] is of interest which can be normalized based on the highest and the lowest gradient magnitude for all pixels.

According to some embodiments, the method 500 shown in FIG. 3 includes applying a Hough transform in step 516 and then in step 518 detecting the OD and calculating the OD centre as follows.

The Hough transformation is applied for circle detection on a selected region of the edge image to find the OD centre in the following way. To detect a circle, a three dimensional parameter matrix P(r,a,b) is used where r is the radius and (a,b) are the centre coordinates. Let (xᵢ,yᵢ) be a candidate binary edge image pixel. The centre coordinates (a,b) of a circle having radius r=R and passing through (xᵢ,yᵢ) lie on a circle of the form:

xᵢ=a+R cos(θ) (equation 3)

yᵢ=b+R sin(θ) (equation 4)

For any radius r,0<r<rₘₐₓ. According to some embodiments, the lower boundary is assigned to be 30 pixels and the upper boundary is assigned to be 80 pixels. Such upper and lower boundary values were assigned for retinal images from the DRIVE and STARE databases based on observations of the OD radius in the images. However, it will be appreciated that other upper and lower boundary values can be used. For example, an upper boundary value of 300 pixels and a lower boundary value 400 pixels were used for retinal images from the Singapore Malay Study database based on observations of the OD radius in the images. That is, the lower and upper boundary values selected are dependent on the image resolution and calibration factor.

The coordinates (a,b) given by equation (2) are calculated and the corresponding elements of matrix P(r,a,b) are increased by one. This process is repeated for every eligible pixel of the binary edge detector output. The elements of the matrix P(r,a,b) having a final value larger than a certain threshold value denotes the circle present in the edge image selected region. Hence, the OD radius and the OD centre can be calculated by this method.

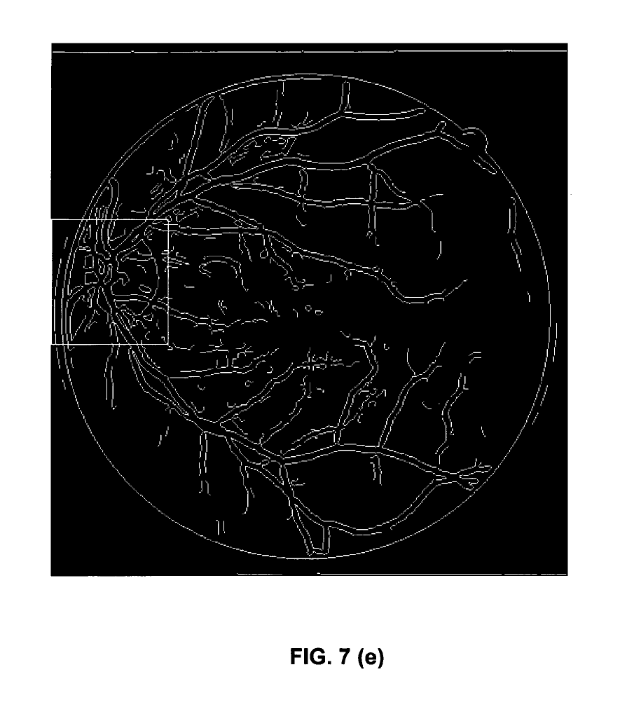

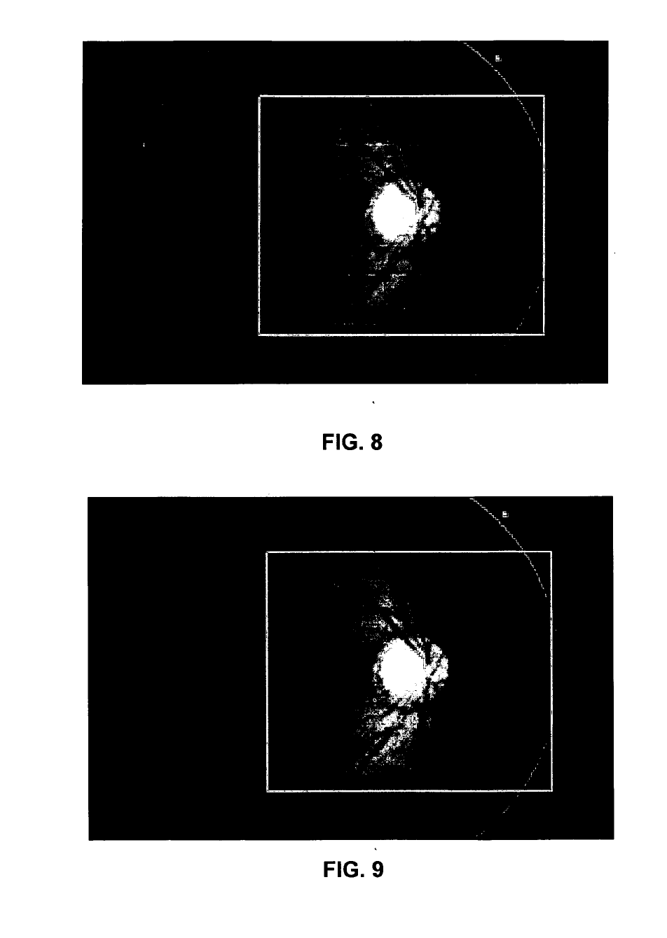

The images in FIGS. 7(a)-7(d) show detection of the OD centre by this process. FIG. 7(a) shows a retinal gray scale image and FIG. 7(b) shows a thresholded image comprising optic disc pixels obtained from the retinal image of FIG. 7(a). FIG. 7(c) shows a square shaped region selected in the edge image (larger version shown in FIG. 7(e)) and FIG. 7(d) shows the centre of the OD indicated by an arrow.

### Experimental Results and Discussion of OD Detection:

The methods 100, 500 were applied to all forty images in the DRIVE database (both the training set and the test set) [17] and forty images from the STARE database [18]. The accuracy and the efficiency in processing time of this technique was also demonstrated on the colour retinal images obtained in the epidemiologic study of the Singapore Malay Eye Study. The performance of the method and algorithm have been evaluated on the basis of two measures, namely, true positive fraction (TPF) and true negative fraction (TNF). This measure is also known as sensitivity. TNF (i.e. specificity) represents the fraction of pixels erroneously classified as OD pixels. We use the following formulae:

$$\begin{matrix}Sensitivity ( TPF ) = \frac{TP}{TP + FN} & ( equation 5 ) \\ Specificity ( TNF ) = \frac{TN}{TN + FP} & ( equation 6 )\end{matrix}$$

where TP, FN, TN, and FP represent true positive, false negative, true negative, and false positive values, respectively. The TPF and TNF values are determined by comparison with human graded images.

The methods 100, 500 according to embodiments of the invention achieved an overall sensitivity of 97.93% and a specificity of 100% for the STARE and DRIVE databases. Reza et al. [12] achieved 96.7% sensitivity and 100% specificity for the same datasets. One hundred images randomly taken from the Singapore Malay Eye Study database [19] were also considered. Each image has a size of 3072×2048 pixels and is either disc or macula centred. The methods 100, 500 according to embodiments of the invention achieved an overall sensitivity of 98.34% and a specificity of 100%. For images from the DRIVE database, it took approximately 0.212 seconds (average) in MATLAB 7.5.0 to produce each output image of size 565×584 on an Intel® Core™ 2 Duo CPU E6750, 2.66 GHz with 3.25 GB of RAM. For the STARE images (700×605) the method according to embodiments of the invention takes 0.216 seconds (average) for each image. For images from the Singapore Malay Eye Study database the method according to embodiments of the invention takes 0.394 seconds (average) for each image.

Hence, methods 100, 500 according to embodiments of the invention provide a robust method for OD detection and measurement in the presence of exudates, drusen and haemorrhages. Embodiments of the methods can automatically select a threshold intensity value based on an approximate OD area. Embodiments of the methods can also search for the OD centre in one or more potential OD regions of reduced area compared with the overall image size using a Hough transformation which results in very accurate and efficient methods.

The inventors' contributions herein can be summarized as providing a fully automatic method for detecting OD which is highly accurate and efficient and facilitation of OD radius and centre detection by applying Hough transformation in the image local area with high efficiency.

Step 404—Region of Interest Computation—Colour Channel Extraction

Returning again to the overall method 400 for measuring vessel caliber, one embodiment of which is shown in FIG. 2, in some embodiments the green colour channel is used for edge and centreline computation because the green channel has the highest contrast between the vessels and the background compared to the other colour channels. However, in other embodiments the red or blue colour channel may be used.

The maximum boundary of the zone B area is selected in the chosen colour channel image, preferably the green channel image. Zone B is the circular area starting from the distance of 2×OD-radius and ending at 3×OD-radius around the OD centre. With reference to FIG. 8, based on the OD centre, a square shaped region, the centre of which is the optic disc centre, is selected. The area of the selected square shaped region is up to 3×OD-radius in vertical and horizontal distance from the OD centre. The purpose of selecting this specific area is to allow the subsequent pre-processing and gradient operations to be applied in a smaller region of the whole image to achieve higher efficiency.

Step 406—Image Pre-Processing

In the pre-processing step of the method 400, the impulse noise is removed from or reduced in the retinal image and the image is smoothed. In one embodiment impulse noise is removed or reduced by applying median filtering and the image is smoothed by applying a Gaussian smoothing operation as described below.

Median filtering is a non-linear filtering method which reduces the blurring of edges. Median filtering replaces a current point in the image with the median of the brightness in its neighbourhood. The median of the brightness in the neighbourhood is not affected by individual noise spikes and so median smoothing eliminates impulse noise quite well. Further, median filtering does not blur edges.

According to preferred embodiments, median filtering is applied iteratively for better results in noise removal from the image. For example, median filtering may be applied 2, 3, 4, 5, 6, 7, 8, 9 or 10 or more times, but there is a trade off between the number of iterations and the efficiency of the method. In one embodiment the median filtering is applied 2 times resulting in the median filtered green channel image shown in FIG. 9. For the image shown in FIG. 9, a 5×5 window was considered for the median filter mask. However, other sized windows may be considered for the median filter mask, such as 3×3, 5×5, 7×7, 9×9 or 11×11.

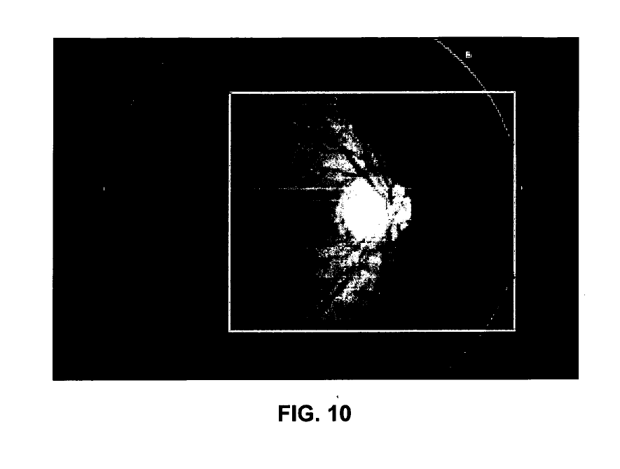

A Gaussian smoothing operation, which is a 2-D convolution method that is used to blur images and remove detail and noise, can be applied to the image. FIG. 10 shows an image obtained after applying Gaussian smoothing and the use of Gaussian smoothing has been found to produce better results in the edge detection methods described herein. The idea of Gaussian smoothing is to use the 2-D distribution as a ‘point-spread’ function and this is achieved by convolution. As the image is a 2-D distribution of pixels, the Gaussian distribution is considered in 2-D form which is expressed as follows:

$$G ( x , y ) = \frac{1}{2 π {σ}^{2}} {e}^{- \frac{{x}^{2} + {y}^{2}}{2 {σ}^{2}}} , \qquad ( equation 7 )$$

where σ is the standard deviation of the distribution and x and y define the kernel position.

Since the image is stored as a collection of discrete pixels, a discrete approximation to the Gaussian function is produced in order to perform the convolution. In theory, the Gaussian distribution is non-zero everywhere, which would require an infinitely large convolution kernel, but in practice it is effectively zero more than about three standard deviations from the mean and the kernel can be truncated at this point.

In one embodiment a 5×5 window sized Gaussian kernels with a standard deviation of 2 is used. In other embodiments different sized windows and standard deviations may be used. For example, the window size may be 3×3, 5×5, 7×7, 9×9 and the standard deviation may be 1.5, 2.0, 2.5, 3, 3.5, 4, 4.5, 5, 5.5 or 6.

Step 408—First Derivative Operation (Image Gradient Operation)

In one embodiment of the method 400 for measuring vessel calibre shown in FIG. 2, a first derivative in image processing is implemented using the magnitude of the gradient of the image. The gradient of an image ƒ(x,y) at location (x,y) is defined as the two dimensional vector of equation 2 above. This vector has the important geometrical property that it points in the direction of the greatest rate of change of ƒ at location (x,y). For edge detection, we are interested in the magnitude M(x,y) and direction α(x,y) of the vector G[ƒ(x,y)] generally referred to simply as the gradient and which commonly take the values of:

M(x,y)=mag(G[ƒ(x,y)])≈|Gₓ|+G_{y}| (equation 8)

α(x,y)=tan⁻¹(G_{y}/Gₓ) (equation 9)

where the angle is measured with respect to the x axis. M(x,y) is created as an image of the same size as the original, when x and y are allowed to vary over all pixel locations in ƒ. It is common practice to refer to this image as the gradient image.

Step 410—Zone B Area Computation and Selection

After obtaining the gradient image in step 408, the method 400 includes computing the Zone B area in step 410. The edge and centreline images are obtained within the Zone B area only because this is the region of interest of the retinal image and because the reduced area of analysis further improves efficiency. According to one embodiment, the Zone B area is computed via Algorithm 1 below.

ALGORITHM 1

ZONE B AREA (cx; cy, R, grad mag; max row; max col)
optic disc center cx and cy, and radius R
grad_mag is the gradient image
max_row, max_{—} col are maximum row and maximum column

of the image, respectively

create zoneB_im as a blank image with the size of original image;
for r = 2 × R to 3 × R
for θ= 0 to 2π
x = cx + r* x* cos(θ)
y = cy + r* x* sin(θ)
if x ≧ 1 & x ≦ max − row & y ≧ 1 & y max − col
then zoneB_im (x, y) = grad_mag (x, y);
end if
end for
end for
end procedure

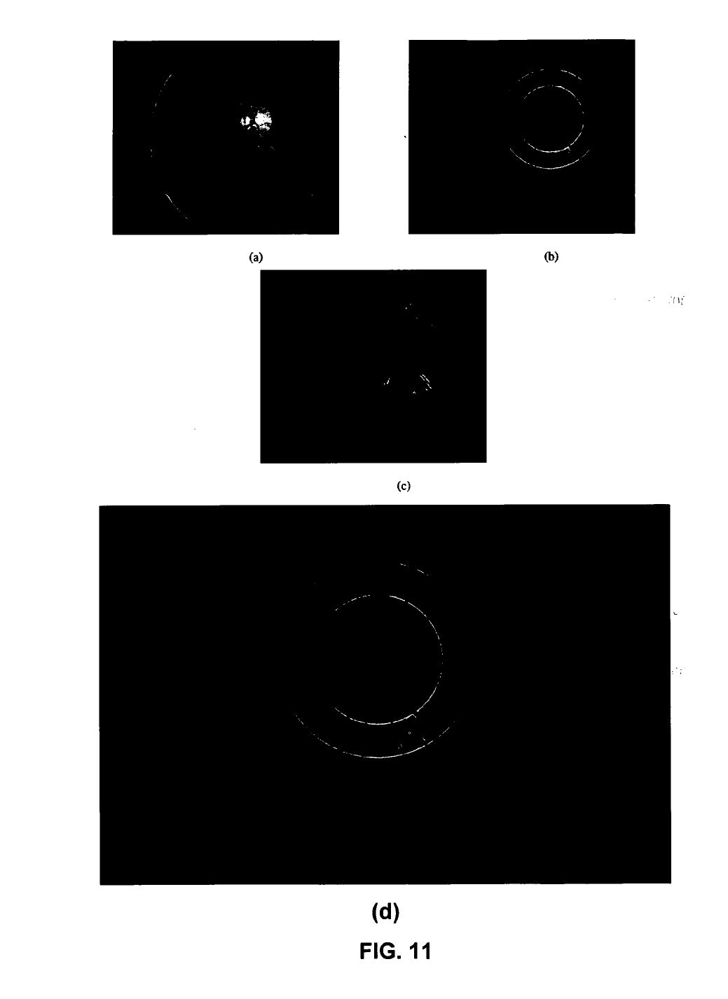

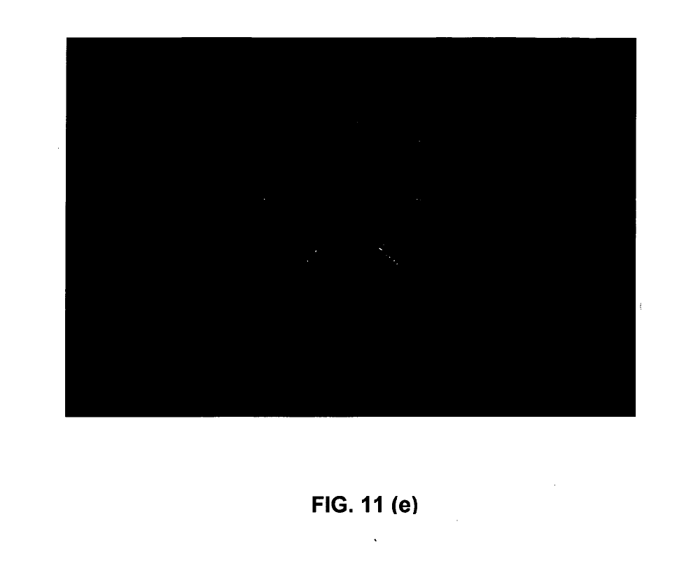

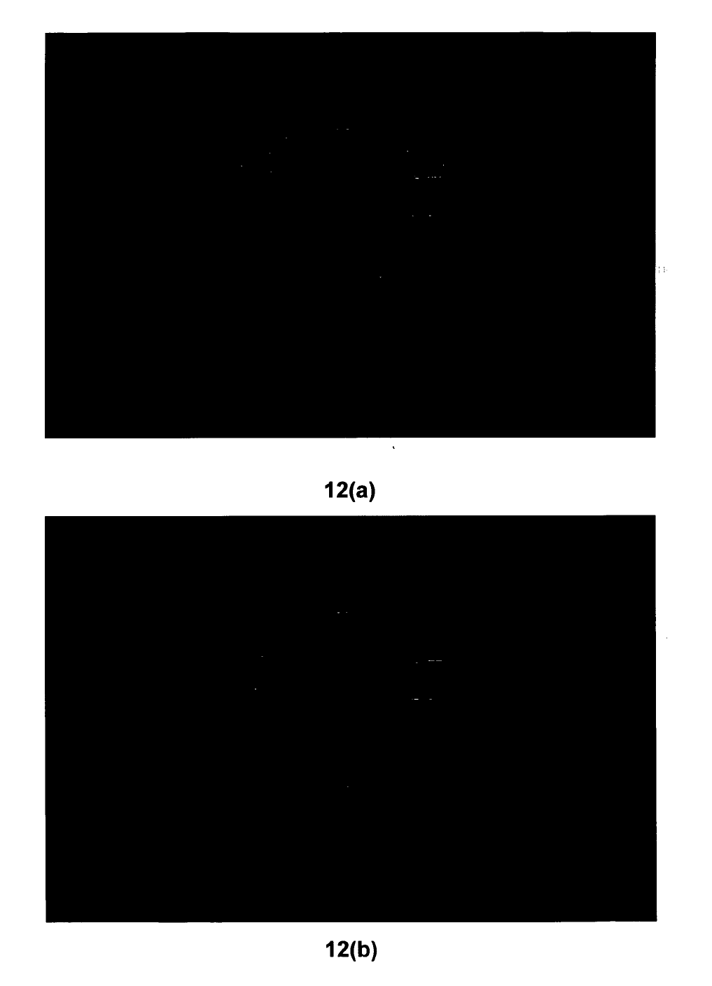

FIG. 11(a) shows a retinal gray scale image and FIG. 11(b) shows the Zone B area of the a retinal gray scale image in FIG. 11(a) (a larger and clearer version of FIG. 11(b) is shown in FIG. 11(d)). FIG. 11(c) shows the gradient magnitude image of the Zone B area image in FIG. 11(b) and FIG. 11(e) shows a larger and clearer version of FIG. 11(c). The pixel grouping operations are only applied to the Zone B area to obtain the vessel edges and vessel centreline as described below.

Step 412—Edge Pixel Grouping and Vessel Edge Determination

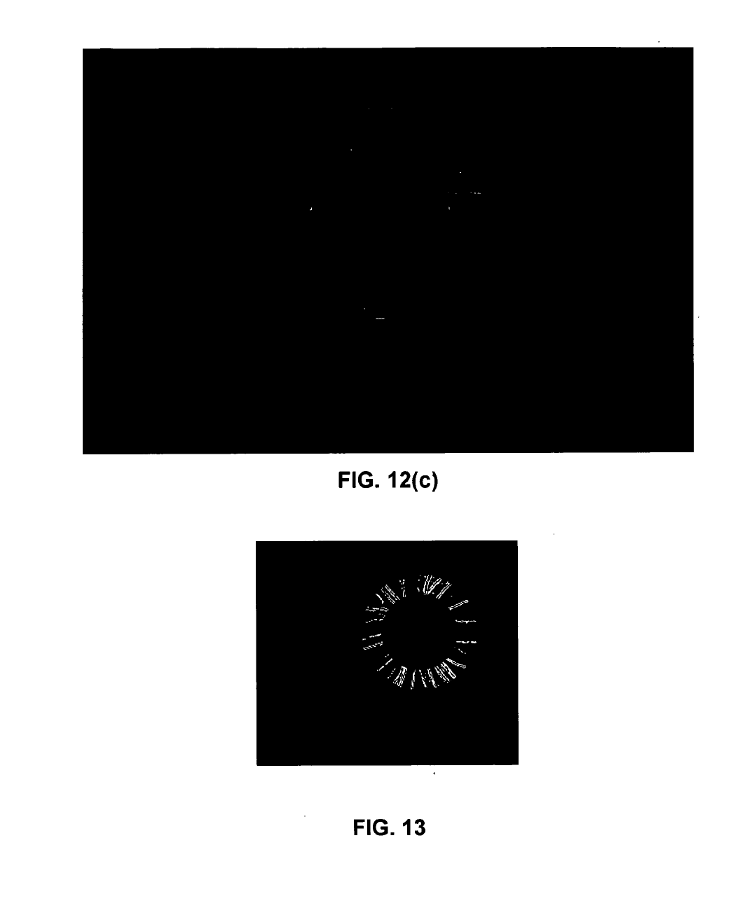

The method 400 for measuring vessel calibre shown in FIG. 2 includes at step 412 vessel edge detection and pixel grouping. Edge detection in retinal images is complicated by factors such as the central reflex, thick edges, change of contrast abruptly and low contrast between the background and the vessel. Therefore, standard edge detection methods such as Sobel, Canny, Zero crossing and others are not able to detect only the vessel edges. Sometimes the edges detected by these standard edge detection methods are broken and this background noise produces edges. These standard edge detection methods may be used in the other methods, aspects and embodiments of the invention. In addition, using the thresholding method in the gradient image is not suitable, also due to these factors. FIGS. 12(a)-12(c) respectively show the edge images produced by the Sobel method (threshold=0.02 and applying thinning), the Canny method (threshold=0.08) and the Zero crossing method (threshold=0.002). FIG. 13 shows the output image after thresholding the gradient magnitude image of the first derivative in the image. The poor contrast is particularly evident in FIGS. 12(a)-12(c) and the image of FIG. 13 comprises thick vessel edges and central reflex.

To address these issues the gradient magnitude of the first derivative in the image is first considered. The distribution of the gradient magnitude and the intensity profile in the original smoothed image is used to locate the start point of the vessel edges. Then, based on this start point, a region growing technique is used for tracking the vessel edges. The region growing technique grows regions from the pixels with gradient magnitude values satisfying specific criteria. The edge pixel start point computation and pixel grouping for edge detection are described in further detail below.

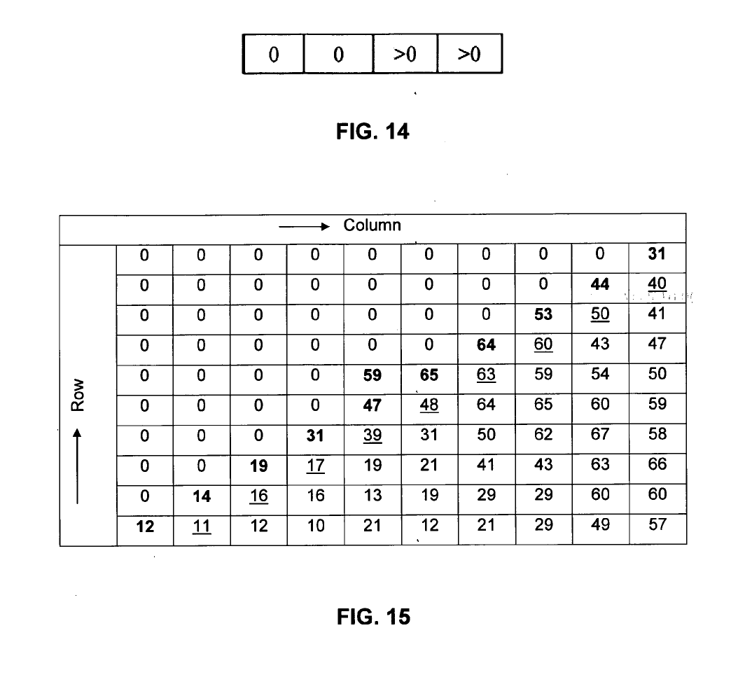

According to preferred embodiments, to determine the edge pixel start point, the border of the zone B area is traversed through and the gradient magnitudes of the border pixels are listed. The traversal process is started from the OD centre with a distance 2×OD radius in number of pixels and an angle of 0 degrees. In one embodiment a pixel is selected from the zone B area which has the following selected criteria: the pixel has two neighbouring pixels which have non zero values in the Zone B area and also has two neighbouring pixels which have zero values. This is represented in FIG. 14.

The method then includes considering the next row with incrementing angle and tracing the pixels which also satisfy the same criteria. This is the second pixel of interest. Once a pixel is considered, a flag value is assigned to mark that pixel. For further progressing the traversal process, the method includes considering the second pixel as the centre of a 3×3 mask, and based on this a pixel is selected which has a null flag value and neighbouring pixels having an intensity value of zero. In this way all the boundary pixels are traced which are checked for selecting as the start pixel of an edge. FIG. 15 shows a table of pixel values in which the bold pixels are traversed and the underlined pixels are not considered for traversal.

It will be noted that the circular path for obtaining the border pixels in the zone B area is not used as the exact position of some pixels may be missed due to the discretization problem. Further, the above method is faster than the trigonometric computation and provides the actual pixels of interest with the selected criteria. In addition, it is desirable to consider all the pixels of interest sequentially, which may not be possible with a circular path due to discretization and rounding issues from the exact trigonometric computations.

Once the boundary pixels are obtained, the distribution of the gradient magnitudes of the pixels is checked to determine the start pixel of a vessel edge. For this the pixel value is checked to determine whether it is greater than or equal to the value of the neighbouring pixels. The neighbouring pixels considered may be before or after the start pixel in the list. In one embodiment the neighbouring pixels considered are two pixels before or after the start pixel in the list. In some embodiments the magnitude of a pixel must be greater than the magnitude of two pixels before it and two pixels after it in the list.

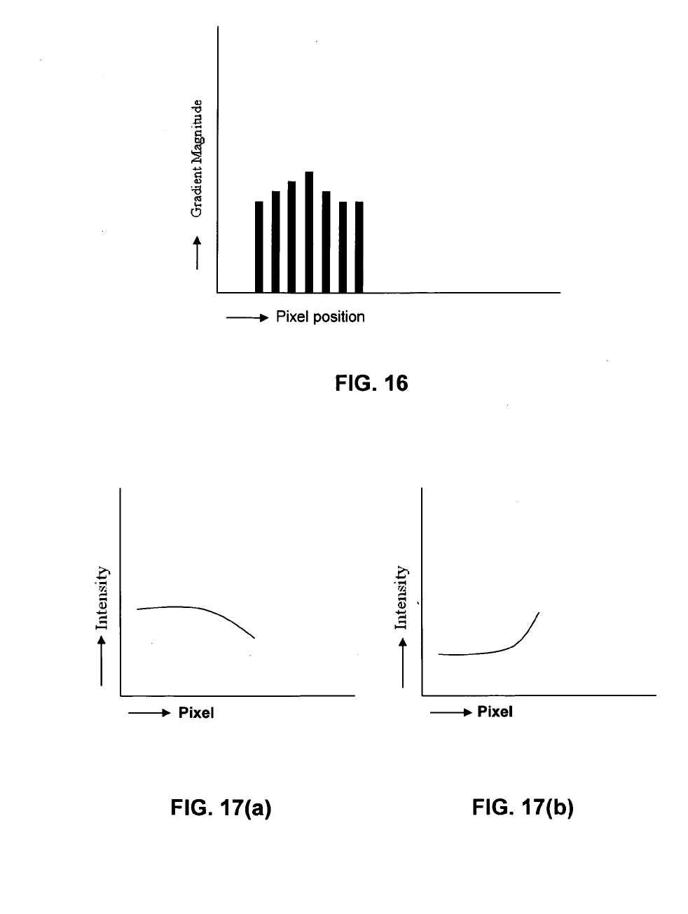

Ordinarily, we do not consider the diagonal pixels which may fall in the searching order (in zone B border pixels). This is because these are the inner pixels other than the cross-section and sometimes fail to provide this edge pattern. The diagonal pixel is determined by considering any three consecutive pixels as the vertices of a triangle and then by computing its determinant. FIG. 16 shows an example of a distribution of the gradient magnitudes to consider a pixel as a starting edge pixel.

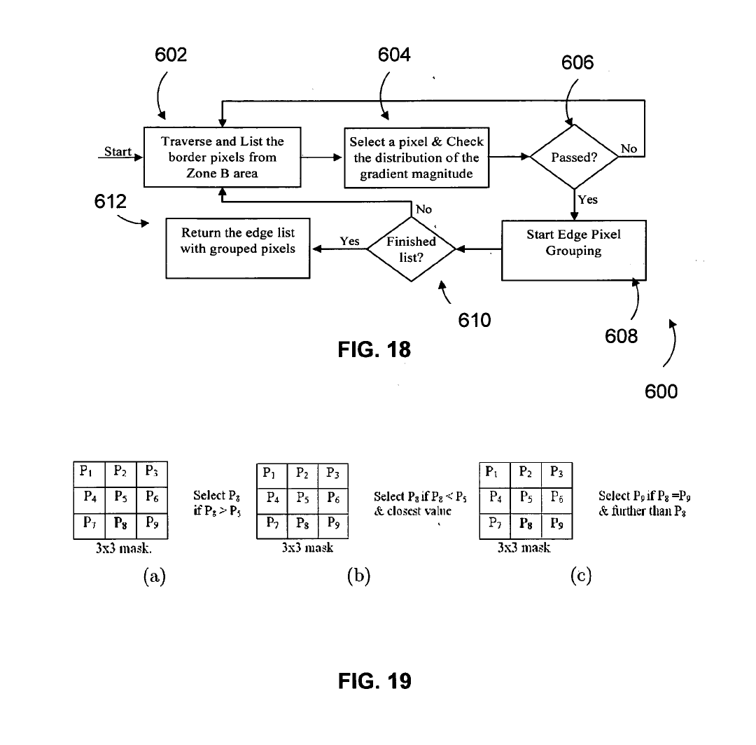

After obtaining the start pixel of the potential vessel edge, the method includes searching for the pixels to group them for obtaining a potential vessel edge. Once the pixel grouping is finished the next start point of a second potential vessel edge may be searched for. The method continues until the end of the zone B border pixel list. The edge pixel grouping method is shown in FIG. 18 and described below.

The method can also include checking the intensity profile in the original smoothed image, such as the smoother green channel image, to confirm whether it is the first edge or the second edge. FIG. 17(a) shows the intensity profile of a vessel first edge. This could also be the intensity profile of a central reflex second edge. FIG. 17(b) shows the intensity profile of a vessel second edge. FIG. 17(b) could also be the intensity profile of a central reflex first edge.

For each potential edge start-point the edge pixel grouping method is applied for constructing a potential vessel edge. The edge pixel grouping method adopts a rule based approach to group the pixels in an edge which can overcome the local contrast variation in the image. The region growing method traces the appropriate pixels from the pixel's neighborhood and merges them in a single edge. The pixel grouping method works as follows. From the start-point, the method searches for its 3×3 neighborhood and finds the gradient magnitudes of the pixels potential for region growing. We note that the direction of the region growing for the edge is in the opposite direction of the OD location; because the vessels are traversing away from the OD. In this direction, we consider the pixel which has the value greater than or equal to the current pixel. If all the values are lower than the current pixel we select the closet one.

FIGS. 19(a)-(c) show criteria used for edge pixel grouping according to one embodiment in which a 3×3 neighbourhood mask is used. In FIG. 19(a), pixel P₈ is selected if the value of P₈ is greater than P₅. In FIG. 19(b), pixel P₈ is selected even if the value of P₈ is less than the value of P₅, but has a value closest to the value of the previous pixel. FIG. 19(c) shows an embodiment in which the pixel with the maximum distance is selected if the highest value is shared between two or more pixels. In FIG. 19(c) pixel P₉ is selected if the value of P₉=P₈ because P_{g} is a greater distance than P₈. For the distance measure, the most distant pixel from immediately before 3 to 5 pixels in the grouped edge pixel is selected.

We select the furthest pixel if more than one pixel has the potential to be considered for the edge. The edge pixel grouping method stops at the end of the zone B area or if there is no pixels which can satisfy the criteria defined for edge grouping method.

We note that traditional edge detection methods such as Canny, Sobel and/or Zero crossing can be applied from which the edges can be reconstructed based on broken edges' slope information in the zone B area. Then detected edges can then be provided to the next steps for noise removal and potential vessel edge selection.

Step 414—Potential Vessel Edge profiling and Length Computation

The edge profiling method filters out the noise and background edges, and finds the edges which belong to vessels. The method checks the intensity levels in the image on both sides of an edge within a specific direction. For this, each of the edge pixels are considered to obtain two pixel positions which are located vertically and within a certain distance from this edge pixel. For this, each pixel along with its neighboring pixel in the edge is considered as line end-points. The slope and actual direction of the lineare computed to find the points on both sides of the current edge pixel. The method is as follows. Let us consider the two end-points of the line are (x₁, y₁) and (x₂, y₂), and the angle θ (actual angle in the image) is computed from the slope and direction of the line which are slope and direction. Let us assume that (x₂, y₂) is the second end-point i.e., located further from the OD compared to the first end point; we find the value of θ as follows. If θ<0 and if y₂≧, y₁ & x₂≧x₁ then θ=θ+π. On the other hand, if θ<0 and if y₂≦y₁ & x₂≦x₁ then θ=θ+2π. If θ>0 and if y₂≧y₁ and x₂≦x₁ then θ=θ+π. Once the actual angle is computed, the point located on left side of the edge point (x₂,y₂) is computed as: ((y₂−r*sin(θ+π/2)),(x₂+r*cos(θ+π/2)) and the point on the right side of the edge point is: ((y₂−r*sin(θ+3π/2)),((xₓ+r*cos(θ+3π/2)) where r is the normal distance from the point (x₂,y₂).

After computing the pixel positions on both sides of each of the edge points, the intensity levels for these positions in the image are obtained. Usual vessel edge profile is high-to-low for the outside-to-inside pixels' intensity levels and low-to-high for the inside-to-outside pixels' intensity levels. For blood vessels, this profile is consistent, whereas for noise, this profile is random. Therefore, the consistent profile value (e.g., low-to-high or high-to-low is more 80%) for each of the potential edges are considered for filtering the true vessel edges and discard the noise edges. After profiling the edges the length of an edge is also computed to check if it passes a certain threshold value for a vessel edge.

Step 416—Vessel Identification and Centerline Detection

After profiling the edges and thresholding the edge length the potential vessel edges are obtained. Then an edge is defined as the first edge of a vessel if it returns a profile value for high-to-low. The edge is defined as the second edge if the profile value is low-to-high. Then we merge these edges for individual blood vessels based on the likelihood of the first edge and second edge of a vessel. Generally, after applying a Gaussian derivative and edge tracking methods two edges are obtained for any blood vessel if there is no central reflex. If there is a central reflex in the vessel, it may be two or three or four edges based on the intensity levels of the central reflex. In general, the width of the central reflex is approximately ⅓ of the vessel width. Considering this, we merge the edge labeled as first and second edge if there is no other first or second or first-second combination within approximately the same distance. The distance is measured as the Euclidian distance between the two edge start-points. If we have first-first-second combination of the edges, we check the overall distance between the first and last edge, and between the middle and last edge. If the conditions satisfy the edges to be part of a vessel, we define the edges belonging to an individual vessel. A similar approach is applied for first-second-second combination. For first-second-first-second we check all the distances; the first first-second pair, the second first-second pair, the second-first (i.e., the second and the third edge which is the width of the central reflex) and the first and last edge pair (i.e., the width of that cross-section). If these distances satisfy the vessel edge-central reflex properties, we define these as a single vessel. Otherwise, the first first-second edge pair is defined as one vessel and the second first-second starts to compute the next vessel edge merging process.

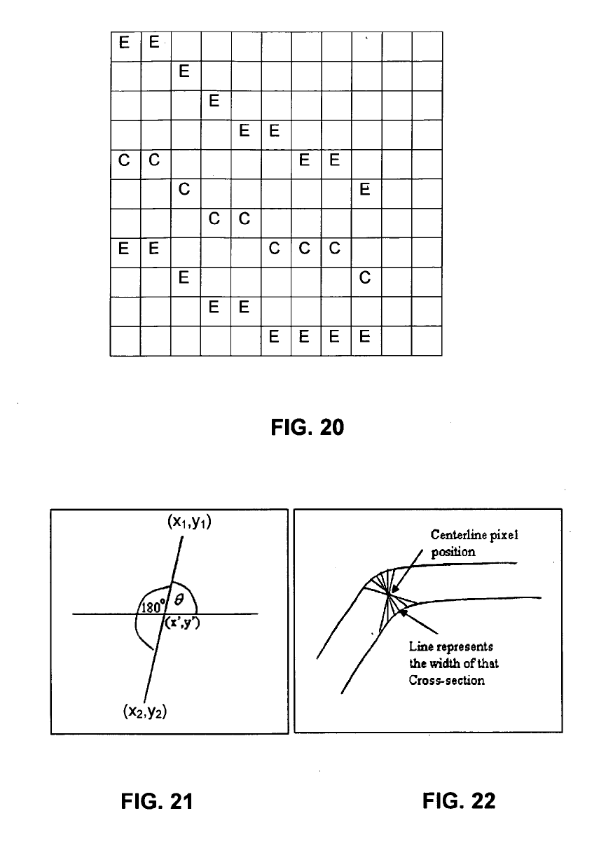

The edges for each vessel may be grouped by listing the pixels in each edge. From this the centreline of each of the blood vessels can be calculated by selecting a pixel pair from the edge pixel lists (in order) and averaging them. FIG. 20 shows a grid of centreline (C) pixels and edge (E) pixels.

FIG. 18 shows a method 600 for selecting the start pixel of a vessel edge according to one embodiment of the invention. This method may also be used to obtain the edge for the central reflex. In step 602 the pixels from Zone B are traversed and listed. In step 604 a pixel is selected and the distribution and gradient magnitude of the selected pixel is checked. In step 606 the selected pixel is assessed against the selected criteria. If the selected criteria are passed, the method continues to step 608 in which the distribution of the intensity profile is checked. If the selected criteria are not passed, the method returns to step 602.

After step 608 if the selected pixel passes the intensity criteria in the distribution of the intensity profile, the method 600 continues to step 612 in which the next edge start pixel is searched for in the border pixels list. If the selected pixel does not pass the intensity criteria the method returns to step 602. In step 614 the pixel is selected if its gradient magnitude is within a certain range of the first edge pixel. In step 616 the pixel is selected as the start of the second edge of the vessel if its intensity profile passes the criteria. The method 600 may also return the edge for the central reflex.

To overcome the selection of the central reflex point as an edge start point, the threshold of the gradient magnitude is set as less than 40% of the vessel edge magnitude. This value is taken based on observation. However, other values may be set as the threshold value, for example, less than one of the following values: 20%, 25%, 30%, 45%, 50%, 55% or 60%.

In some cases the threshold value does not satisfy this criteria. To ensure the central reflex is not considered as a vessel, the edge pixels start point distances and parallel edge criteria may be considered to merge the central reflex into the vessel.

To eliminate the central reflex, when a first edge and second edge combination are received in an edge distance range, neighbouring vessels within a neighbouring vessel distance range are checked. The edge distance range may be between 5 and 25 pixels and/or 50 and 100 microns. The edge distance range may be within 5, 6, 7, 8, 9, 10, 11, 12, 13, 14, 15, 16, 17, 18, 19 or 20 pixels. The edge distance range may be within 50, 55, 60, 65, 70, 75, 80, 85, 90, 95 or 100 microns. In one embodiment the edge distance range is 15 pixels and/or 75 microns.

The neighbouring vessel distance range may be between 20 and 100 pixels or more. In one embodiment the neighbouring vessel distance range is within 60 pixels. The neighbouring vessel distance range of 60 pixels is based on the fact that the maximum width of a vessel can be fifty pixels in an image size of 2048×3072.

To perform the checking, once a gradient magnitude for the second edge, which may be a central reflex edge, is set, the other edge of the vessel or central reflex is searched for. For example, if the other edge is the central reflex, it is usually found within 15 pixels. If found, the distance is determined and if it is within the edge distance range the other edge is found.

Once the edge start points are located the distance between the first edge and other edge is determined. If that distance is within the neighbouring vessel distance range, for example within 60 pixels in one embodiments, a check is performed for parallel edge criteria based on the edge points obtained from the edge pixel grouping method described below. Once parallel edge criteria are satisfied then the selected pixels may be assigned as one vessel. Otherwise, the edges are considered to be the edge start points of different vessels. In alternative embodiments, the micron/pixel information can be utilised.

With reference to step 412 of the method 400 for measuring vessel calibre shown in FIG. 2, vessel edge pixel grouping will now be described. For each start pixel of a vessel edge, a region growing technique is used to track the edge of the vessel. With reference to FIGS. 19(a)-19(c), in one embodiment the region growing technique includes checking a neighbourhood of the start pixel to pick the next pixel and thus track the vessel edge. The neighbourhood is checked with a 3×3 mask.

The next pixel considered for region growing may be based on a one or more of the following criteria. The pixel with the highest intensity value in the neighbourhood pixel area may be selected. If more than one pixel in the neighbourhood has the same value, the pixel which is the furthest distance from the start pixel may be selected as the next pixel. Alternatively, the pixel having an intensity value closest to the intensity value of the start pixel may be selected as the next pixel. As a further alternative, the pixel having a value within a predetermined number of units of the value of the start pixel may be selected as the next pixel.

Step 418—Vessel Cross-Sectional Width Computation

The vessel calibre measuring method 400 shown in FIG. 2 includes at step 418 calculating the vessel width. After obtaining the vessels edge image and centreline image, the edge pixels are mapped based on vessel centreline pixel positions to find the vessel cross-sectional width. For this, the method includes selecting a pixel from the vessel centreline image and applying a mask considering the centreline pixel as the mask centre. The purpose of this mask is to find the potential edge pixels, which may fall in width or cross section of the vessels, on any side of the centreline pixel position. Therefore, the mask is applied to the edge image only.

To search all the pixel positions inside the mask, the pixel position is calculated by shifting one pixel at a time until the limit of the mask is reached. For each pixel shift, a rotation of −45 to 225 degrees is performed. To increase the rotation angle, a step size less than 180/(mask length) is used. Accordingly, the step size depends on the size of the mask and every cell in the mask can be accessed using this angle.

For each pixel position, the edge image is searched to check whether it is an edge pixel or not. With reference to FIG. 21, when an edge pixel is found its mirror, e.g. a second edge pixel corresponding to a first edge pixel, can then be found by shifting the angle by 180 degrees and increasing the distance from one to the maximum size of the mask. In this way, a rotational invariant mask is produced and the potential pixel pairs can be selected in order to find the width or diameter of that cross sectional area.

The following equations show one embodiment of the computation of the first edge pixel in the pixel mapping procedure:

x₁=x′+r*cos θ (equation 10)

y₁=y′+r*sin θ (equation 11)

where (x′, y′) is the vessel centreline pixel position;

r=1, 2, . . . (mask size)/2; and

θ=−45°, . . . , 225°.

For any pixel position, if the gray scale value in the edge image is 255 (representing white or an edge pixel in the image) then the pixel (x₂,y₂) in the opposite edge (the mirror of this pixel) may be found considering θ=(θ+180) and varying r, as shown in FIG. 22.

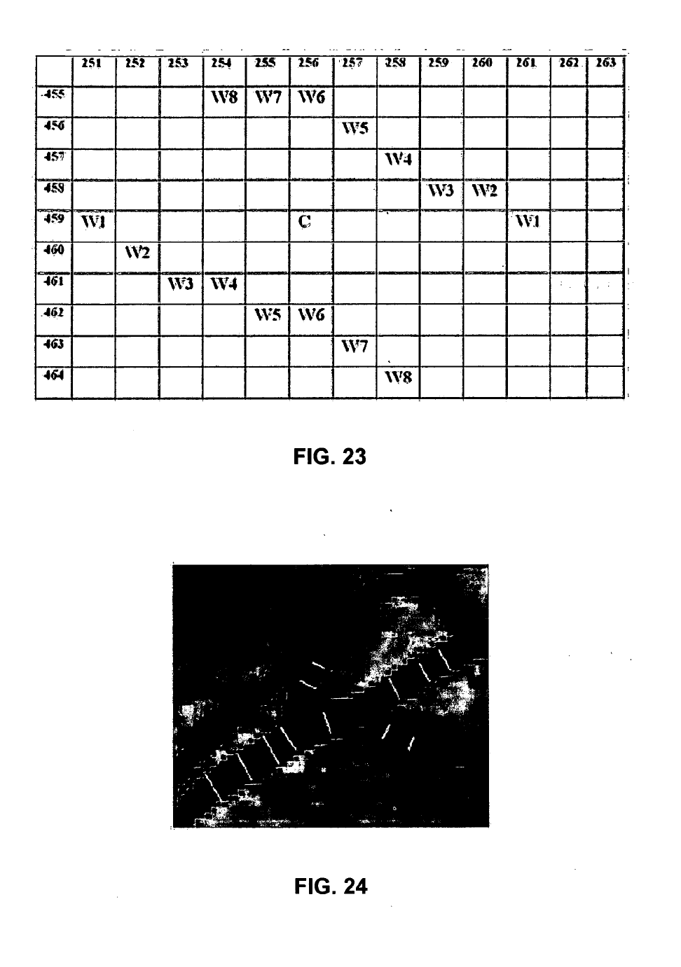

After applying this operation the pixel pairs which are on the opposite edges at the line end points may be found which gives imaginary lines passing through the centreline pixels, as shown in FIG. 22. FIG. 23 shows a grid of potential width edge pair pixels (W1, W2, W3, . . . ) for a vessel cross-section with a centreline pixel (C).

From these pixel pairs the minimum Euclidian distance is:

\sqrt{(x₁−x₂)²+(y¹−y²)²} (equation 12)

and the width of that cross-section can be found. In this way, the width for all vessels may be measured, including vessels having a width one pixel wide.

### Central Reflex Detection:

Methods for measuring the vessel central reflex according to embodiments of the invention will now be described. The central reflex edges are detected with the same process for detecting the potential vessel edges described above in Step 414 of method 400.

After profiling and length thresholding the individual vessel edges are identified. From this step the central reflex edges are filtered out for further processing. Once a vessel is identified the edges of the central reflex in the list are checked based on the start points of the edges. If two edges of the central reflex are identified their length is checked. If they satisfy the length threshold (which is approximately the same as vessel length), the edges are considered as the central reflex edges. Otherwise, they are not considered as the central reflex. If one or none are identified, start point between the two edges' start point of the vessel are checked by the same method used for vessel edge start pixel detection, edge pixel grouping and profiling for finding possible edges. Then the length of the edges and width of the central reflex are checked to decide whether or not the edge is a central reflex. Once both edges of central reflex are identified the mean width of the central reflex is computed. If the mean width is approximately ⅓ of the mean width of the vessel, the identified central reflex is considered the central reflex.

### Experimental Results of Vessel Calibre Calculation:

The accuracy of the invention was measured qualitatively by comparing with width measured by plotting the centreline pixel and its surrounding edge pixels. Vessel cross-sections from ten different images were considered which showed that embodiments of the invention are very accurate. FIG. 23 shows the grid for a cross-section of a blood vessel where is the centreline pixel and W1 to W8 are potential width end points. FIG. 24 depicts the detected width for some cross-sectional points indicated with white lines (enlarged).

For quantitative evaluation we considered ten images (each 3072×2048 pixels which were captured with a Canon D-60 digital fundus camera) with manually measured widths on different cross-sections from the Eye and Ear Hospital, Victoria, Australia. For each cross-section, the graded width was obtained from five different experts who are trained retinal vessel graders of that institution. For manual grading a computer program was used where the graders could zoom in and out at will, moving around the image and selecting various parts. Embodiments of the invention were applied to these images to produce the edge image and vessel centreline image. These images were considered and ninety-six cross-sections of vessels with varying width from one to twenty-seven pixels were randomly picked. The width for each cross-section was measured by the invention which yielded the automatic width measurement labelled automatic width measurement, A. The automatic width measurement, A, and the five manually measured widths, labelled manual width, were compared. The average of the manual width (μ) and the standard deviation on manual widths (σₘ) were calculated and the following formula was used to find the error:

$$\begin{matrix}E = \vert \frac{\frac{( μ - {σ}_{m} ) - A}{( μ - {σ}_{m} )} + \frac{( μ + {σ}_{m} ) - A}{( μ + {σ}_{m} )}}{2} \vert \\ = \vert 1 - \frac{μ \times A}{{μ}^{2} - {σ}_{m}^{2}} \vert\end{matrix} \qquad ( equation 13 )$$

In equation (13), we considered (μ−σₘ) to normalize. This formula is a good measure as the error rate will be less if it is within the interval of one standard deviation. With this formula, we calculated the error and accuracy in all ninety-six cross-sections and achieved an average of 95.8% accuracy in the detection of vessel width. The maximum accuracy is 99.58% and the minimum accuracy is 89.30%. Tables 1 and 2 in the Appendix depict the manual and automatic width measurement accuracy on different cross-sections in an image.

Herein new and efficient techniques for blood vessel width measurement including retinal central reflex detection are described. This approach is a robust estimator of vessel width in the presence of low contrast and noise. The results obtained are significant and the detected width can be directly used in CRAE and CRVE measurements. Further, the method can be used to measure different parameters such as vessel nicking, narrowing, branching coefficients, etc. to predict or diagnose disease.

Advantageously, embodiments of the present invention provide an automatic analysis of retinal vasculature and an efficient and low cost approach for an indication prediction or diagnosis of a disease or condition. The disease or condition may include cardiovascular disease, cardiovascular risk, diabetes and hypertension and/or a predisposition thereto.

Significantly, the present invention overcomes the problems posed by the central reflex in conventional vessel detection and vessel width measurement techniques.

Another advantage of the invention is that computationally expensive pre-defined masks are not required. The use of edge and centreline information for width measurement is very accurate and efficient.

The present invention provides automatic OD area detection, OD centre and radius computation, vessel tracing through vessel edges and centrelines, vessel calibre or cross-sectional width measurements and vessel central reflex tracing and detection.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

All computer programs, algorithms, patent and scientific literature referred to herein is incorporated herein by reference.

### APPENDIX

TABLE I
MEASURING THE ACCURACY OF THE AUTOMATIC WIDTH MEASUREMENT

| | Centreline | | | | | | Auto | | |
|---|---|---|---|---|---|---|---|---|---|
| | pixel | | Detected width end points | | | | width | Error | Accuracy |
| Cross-section | X_{c} | Y_{c} | X₁ | Y₁ | X₂ | Y₂ | (A) | (%) | (%) |
| 1 | 1683 | 1500 | 1691 | 1509 | 1680 | 1495 | 17.805 | 9.01 | 90.99 |
| 2 | 1434 | 855 | 853 | 1436 | 859 | 1432 | 7.211 | 14.52 | 85.48 |
| 3 | 2055 | 629 | 2068 | 632 | 2046 | 628 | 22.361 | 0.86 | 99.14 |
| 4 | 1859 | 519 | 1871 | 519 | 1850 | 520 | 21.024 | 2.50 | 97.50 |
| 5 | 2259 | 815 | 2259 | 811 | 2259 | 824 | 13 | 0.54 | 99.46 |
| 6 | 2350 | 1077 | 2350 | 1070 | 2350 | 1084 | 14 | 12.39 | 87.61 |
| 7 | 2233 | 1317 | 2239 | 1314 | 2239 | 1322 | 11.314 | 6.51 | 93.49 |
| 8 | 2180 | 1435 | 2189 | 1431 | 2172 | 1440 | 19.235 | 4.61 | 95.39 |
| 9 | 1618 | 1331 | 1335 | 1623 | 1330 | 1617 | 7.81025 | 10.46 | 89.54 |
| 10 | 1475 | 1164 | 1169 | 1479 | 1162 | 1474 | 8.6023 | 16.80 | 83.20 |
| 11 | 2045 | 1451 | 2054 | 1452 | 2042 | 1452 | 12 | 9.24 | 90.76 |
| 12 | 1443 | 1000 | 999 | 1446 | 1004 | 1440 | 7.81025 | 8.77 | 91.23 |

TABLE 2
MANUALLY MEASURED WIDTHS FOR IMAGE CROSS-SECTIONS

| | Manually measured width (μ) | | | | | Mean width | Standard |
|---|---|---|---|---|---|---|---|
| Cross-section | one | two | three | four | five | (μ) (in pixels) | Deviation (σₘ) |
| 1 | 86.87 | 107.31 | 102.2 | 107.31 | 97.09 | 19.6 | 1.6733 |
| 2 | 45.99 | 51.1 | 35.77 | 56.21 | 35.77 | 8.8 | 1.7889 |
| 3 | 112.42 | 117.53 | 107.31 | 117.53 | 112.42 | 22.2 | 0.8366 |
| 4 | 107.31 | 112.42 | 107.31 | 117.53 | 107.31 | 21.6 | 0.8944 |
| 5 | 66.43 | 76.65 | 61.32 | 71.54 | 61.32 | 13.2 | 1.3088 |
| 6 | 61.32 | 71.54 | 61.32 | 71.54 | 56.21 | 12.6 | 1.3416 |
| 7 | 56.21 | 66.43 | 56.21 | 66.43 | 66.43 | 12.2 | 1.0954 |
| 8 | 107.31 | 107.31 | 102.2 | 102.2 | 97.09 | 20.2 | 0.8366 |
| 9 | 35.77 | 51.1 | 45.99 | 56.21 | 40.88 | 9 | 1.5811 |
| 10 | 35.77 | 45.99 | 35.77 | 45.99 | 30.66 | 7.6 | 1.3416 |
| 11 | 56.21 | 66.43 | 45.99 | 61.32 | 66.43 | 11.6 | 1.6733 |
| 12 | 40.88 | 56.21 | 35.77 | 45.99 | 45.99 | 8.8 | 1.4832 |

### REFERENCES

[1] T. Y. Wong, A. Kamineni, R. Klein, A. R. Sharrett, B. E. Klein, D. S. Siscovick, M. Cushman, and B. B. Duncan, “Quantitative retinal venular calibre and risk of cardiovascular disease in older persons,” Archives of Internal Medicine, vol. 266, pp. 2388-2394, 2006.
[2] T. Y. Wong, R. Klein, B. E. K. Klein, S. M. Meuer, and L. D. Hubbard, “Retinal vessel diameters and their associations with age and blood pressure,” Investigative Ophthalmology and Visual Science, vol. 44(11), pp. 4644-4650, 2003.
[3] T. Y. Wong, L. D. Hubbard, E. K. Marino, R. Kronmal, A. R. Sharrett, D. S. Siscovick, G. Burke, and J. M. Tielsch, “Retinal microvascular abnormalities and blood pressure in older people: The cardiovascular health study,” British Journal of Ophthalmology, vol. 86(9), pp. 1007-1013, 2002.
[4] W. Zhiming and T. Jianhua, “A fast implementation of adaptive histogram equalization,” Proceedings of the International Conference on Signal Processing, vol. 2, pp. 1-4, 2006.
[5] J. Sowers, M. Epstein, and E. Frohlich, “Diabetes, hypertension and cardiovascular diseases: an update,” Hypertension, vol. 37(5), pp. 1053-1059, 2001.
[6] L. Huiqi, W. Hsu, M. L. Lee, and T. Y. Wong, “Automatic grading of retinal vessel calibre,” IEEE Transactions on Biomedical Engineering, vol. 52, pp. 1352-1355, 2005.
[7] M. S. R. L Zhou, L. J. Singerman, and J. M. Chokreff, “The detection and quantification of retinopathy using digital angiograms,” IEEE Transactions on Medical Imaging, vol. 13, 1994.
[8] X. Gao, A. Bharath, A. Stanton, A. Hughes, N. Chapman, and S. Thom, “Measurement of vessel diameters on retinal images for cardiovascular studies,” Proceedings of Medical Image Understanding and Analysis, pp. 1-4, 2001.
[9] J. Lowell, A. Hunter, D. Steel, A. Basu, R. Ryder, and R. L. Kennedy, “Measurement of retinal vessel widths from fundus images based on 2-d modeling,” IEEE Transactions on Medical Imaging, vol. 23, no. 10, pp. 1196-1204, October 2004.
[10] O. Brinchman-hansan and H. Heier, “Theoretical relations between light streak characterstics and optical properties of retinal vessels,” Acta Ophthalmologica, vol. 179, no. 33, 1986.
[11] Huajun Ying, Ming Zhang, and Jyh-Charn Liu, “Fractal-based automatic localization and segmentation of optic disc in retinal images,” 29th Annual International Conference of the IEEE Engineering in Medicine and Biology Society (EMBS), 2007.
[12] Ahmed Wasif Reza, C Eswaran, and Subhas Hati, “Automatic tracing of optic disc and exudates from color fundus images using fixed and variable thresholds,” Journal of Medical System, vol. 33, pp. 73-80, 2009.
[13] Huiqi Li and Opas Chutatape, “Automatic location of optic disc in retinal images,” Proceedings of IEEE International Conference on Image Processing, pp. 837-840, 2001.
[14] Marc Lalonde, Mario Beaulieu, and Langis Gagnon, “Fast and robust optic disc detection using pyramidal decomposition and hausdorff-based template matching,” IEEE Transactions on Medical Imaging, vol. 20(11), pp. 1193-1200, 2001.
[15] M. Foracchia, E. Grisan, and A. Ruggeri, “Retinal images by means of a geometrical model of vessel structure,” IEEE Transactions on Medical Imaging, vol. 23(10), pp. 1189-1195, 2004.
[16] S. Kaushik, A. G. Tan, P. Mitchell, and J. J. Wang, “Prevalence and associations of enhanced retinal arteriolar light reflex a new look at an old sign,” Ophthalmology, vol. 114, p. 113120, 2007.
[17] J. J. Staal, M. D. Abramoff, M. Niemeijer, M. A. Viergever, B. van Ginneken, “Ridge based vessel segmentation in color images of the retina”, IEEE Transactions on Medical Imaging, 2004, vol. 23, pp. 501-509.
[18] Stare Project, http://www.ces.clemson.edu/˜ahoover/stare/ (last accessed on 24 Aug. 24 Aug. 2009).
[19] Athena W. P. Foong, Seang-Mei Saw, Jing-Liang Loo, Sunny Shen, Seng-Chee Loon, Mohamad Rosman, Tin Aung, Donald T. H. Tan, E. Shyong Tai, Tien Y. Wong, “Rationale and Methodology for a Population Based Study of Eye Diseases in Malay People: The Singapore Malay Eye Study (SiMES)” Ophthalmic Epidemiology, vol. 14(1), 25-35, 2007.
[20] Wong T Y, Klein R, Couper D J, Cooper L S, Shahar E, et al.: Retinal microvascular abnormalities and incident stroke: The atherosclerosis risk in communities study. Lancet 2001; 358:1134-1140.
[21] Wong T Y, Kamineni A, Klein R, Sharrett A R, Klein B E, et al.: Quantitative retinal venular caliber and risk of cardiovascular disease in older persons: The cardiovascular health study. Arch Intern Med 2006; 166:2388-2394.
[22] Nguyen T T, Wang J J, Islam F M, Mitchell P, Tapp R J, et al.: Retinal arteriolar narrowing predicts incidence of diabetes: The australian diabetes, obesity and lifestyle (ausdiab) study. Diabetes 2008; 57:536-539.
[23] Wang J J, Rochtchina E, Liew G, Tan A G, Wong T Y, et al.: The long-term relation among retinal arteriolar narrowing, blood pressure, and incident severe hypertension. Am J Epidemiol 2008 Jul. 1; 168(1):80-8
[24] Klein R, Klein B E, Moss S E, Wong T Y: Retinal vessel caliber and microvascular and macrovascular disease in type 2 diabetes: Xxi: The wisconsin epidemiologic study of diabetic retinopathy. Ophthalmology 2007; 114:1884-1892.

1. A method for detecting an optic disc in a retinal image broadly including the steps of:
analyzing an image histogram of the retinal image to determine intensity levels;
analyzing the determined intensity levels to determine a threshold intensity for potential optic disc regions;
determining the number of pixels for each potential optic disc region; and
calculating the centre of each potential optic disc region from the number of pixels in each potential optic disc region to thereby detect the optic disc.

2. The method of claim 1 wherein the determination of the number of pixels for each potential optic disc region is performed using a region growing technique.

3. The method of claim 1 wherein the calculation of the center of each potential optic disc region is performed using a Hough transformation.

4. A method for measuring vessel calibre in a retinal image including the steps of:
determining a distribution of gradient magnitude and intensity profile in the retinal image to identify one or more boundary pixels of zone B area which can be potential vessel edge start pixel;
determining a start pixel of a vessel edge from the identified one or more boundary pixels;
mapping a vessel edge from the determined start pixel using a region growing technique; and
measuring the vessel calibre from the mapped vessel edges.

5. The method of claim 4 further including the step of edge profiling for removing noise and background edges or edge thresholding for removing noise and background edges.

6. (canceled)

7. The method of claim 4 further including the step of applying a rule based technique to identify and/or define individual vessels' edges or further including the step of calculating a vessel centreline from the mapped vessel edges wherein the calculated vessel centerline is used with the mapped vessel edge to measure the vessel caliber.

8. (canceled)

9. The method of claim 4 wherein the start pixel of the vessel edge is determined by selecting a pixel from the zone B area which is part of a pattern.

10. (canceled)

11. The method of claim 4 wherein the mapping of a vessel edge is performed by selecting pixels in neighbouring rows and/or columns which also satisfy a criteria to generate a boundary pixel list or comprises determining an edge profile by selecting one or more pixel on both sides of the start pixels to measure their intensity levels.

12. (canceled)

13. The method of claim 4 wherein the intensity levels are measured in a green channel image.

14. The method of claim 4
wherein the start pixel of a vessel second edge is determined from the boundary pixel list using the gradient magnitude and intensity profile or from the edge profile which shows opposite intensity levels than the first edge within the same direction.

15. (canceled)

16. The method of claim 4 wherein the detection of blood vessels is performed by adopting a rule based technique which considers the first edge and second edge combination and a specific distance of the edge start points.

17. The method of claim 4 wherein the calculation of the vessel centreline is performed by grouping the edges for each vessel.

18. The method of claim 4 wherein the measurement of the vessel calibre is performed using a mask which considers a vessel centreline pixel as the centre and determines edge pixels and the mirror of each edge pixel to generate edge pixel pairs from which the width of the cross-section is calculated.

19. A method for measuring a vessel central reflex including the steps of:
determining a distribution of gradient magnitude and intensity profile in the retinal image to identify one or more boundary pixels;
determining a start pixel of a vessel central reflex from the identified one or more boundary pixels;
mapping a vessel central reflex edge from the determined start pixel using a region growing technique;
determining if the vessel central reflex is continuous;
calculating a vessel central reflex centreline from the mapped vessel central reflex edge; and
measuring the vessel central reflex mean width from the mapped vessel central reflex edge and calculated vessel centreline to thereby detect the vessel central reflex.

20. The method of claim 19 wherein once a central reflex boundary pixel is determined, the other edge of the central reflex may be determined.

21. The method of claim 19 wherein other edge of the central reflex may be within 15 pixels and/or 75 microns of the central reflex boundary pixel.

22. The method of claim 19 wherein the region growing of the central reflex includes a stop criterion if the gradient magnitude is within the range of 60% of the start pixel if the value is lower than the current value.

23. A computer program product said computer program product comprising:
a computer usable medium and computer readable program code embodied on said computer usable medium for obtaining or receiving a retinal image, the computer readable code comprising:
computer readable program code devices (i) configured to cause the computer to analyse an image histogram of the retinal image to determine intensity levels;
computer readable program code devices (ii) configured to cause the computer to analyse the determined intensity levels to determine a threshold intensity for potential optic disc regions;
computer readable program code devices (iii) configured to cause the computer to determine the number of pixels for each potential optic disc region; and
computer readable program code devices (iv) configured to cause the computer to calculate the centre of each potential optic disc region from the number of pixels in each potential optic disc region to thereby detect the optic disc.

24. The computer program product of claim 23 wherein computer program code devices (iii) comprise a region growing technique.

25. The computer program product of claim 23 wherein computer program code devices (iv) comprise a Hough transformation.

26. A computer program product said computer program product comprising:
a computer usable medium and computer readable program code embodied on said computer usable medium for obtaining or receiving a retinal image, the computer readable code comprising:
computer readable program code devices (i) configured to cause the computer to determine a distribution of gradient magnitude and intensity profile in the retinal image to identify one or more boundary pixels of zone B area which can be potential vessel edge start pixel;
computer readable program code devices (ii) configured to cause the computer to determine a start pixel of a vessel edge from the identified one or more boundary pixels;
computer readable program code devices (iii) configured to cause the computer to map a vessel edge from the determined start pixel using a region growing technique; and
computer readable program code devices (iv) configured to cause the computer to measure the vessel calibre from the mapped vessel edges.

27. The computer program product of claim 26 further comprising computer readable program code devices (vii) configured to cause the computer to apply a rule based technique to identify and/or define individual vessels' edges.

28. The computer program product of claim 26 further comprising computer readable program code devices (viii) configured to cause the computer to calculate a vessel centreline from the mapped vessel edges wherein the calculated vessel centerline is used with the mapped vessel edge to measure the vessel calibre.

29. A computer program product said computer program product comprising:
a computer usable medium and computer readable program code embodied on said computer usable medium for obtaining or receiving a retinal image, the computer readable code comprising:
computer readable program code devices (i) configured to cause the computer to determine a distribution of gradient magnitude and intensity profile in the retinal image to identify one or more boundary pixels;
computer readable program code devices (ii) configured to cause the computer to determine a start pixel of a vessel central reflex from the identified one or more boundary pixels;
computer readable program code devices (iii) configured to cause the computer to map a vessel central reflex edge from the determined start pixel using a region growing technique;
computer readable program code devices (iv) configured to cause the computer to determine if the vessel central reflex is continuous;
computer readable program code devices (v) configured to cause the computer to calculate a vessel central reflex centreline from the mapped vessel central reflex edge; and
computer readable program code devices (vi) configured to cause the computer to measure the vessel central reflex mean width from the mapped vessel central reflex edge and calculated vessel centreline to thereby detect the vessel central reflex.

30. The computer program product of claim 29 further comprising computer readable program code devices (viii) configured to cause the computer to determine the other edge of the central reflex.

31. (canceled)
